(19) United States
(12) Patent Application Publication
(10) Pub. No.: US 2026/0051112 A1
(43) Pub. Date: Feb. 19, 2026

(54) INFORMATION PROCESSING SYSTEM, STORAGE MEDIUM, INFORMATION PROCESSING APPARATUS, AND INFORMATION PROCESSING METHOD

(71) Applicant: NINTENDO CO., LTD., Kyoto (JP)

(72) Inventors: Tsubasa SAKAGUCHI, Kyoto (JP); Noritaka OTSUKA, Kyoto (JP); Shinji TAKEI, Kyoto (JP); Eiji MICHIHIRO, Kyoto (JP)

(21) Appl. No.: 19/271,071

(22) Filed: Jul. 16, 2025

(30) Foreign Application Priority Data
Aug. 15, 2024 (JP) 2024-135777

(51) Int. Cl. G06T 15/40

(52) U.S. Cl. CPC G06T 15/40; G06T 2210/62

(57) ABSTRACT

A second one of information processing terminals is configured to generate a second virtual space in which objects are arranged, update a position of at least a virtual camera in the second virtual space based on an operation input performed by a second user, set a range in the second virtual space corresponding to region information stored in a server, as at least one second user region, designate one of the second user regions as a designated user region based on an operation input performed by the second user, and when at least the virtual camera is located outside the designated user region, render an image of the second virtual space based on the virtual camera by a rendering process including a first effect of hiding at least a portion of the objects arranged in the designated user region.

### CROSS REFERENCE TO RELATED APPLICATION

This application claims priority to Japanese Patent Application No. 2024-135777, filed on Aug. 15, 2024, the entire contents of which are incorporated herein by reference.

### FIELD

The technology disclosed herein relates to information processing systems, storage media, information processing apparatuses, information processing methods, and the like that execute processing using an object in a virtual space.

### BACKGROUND AND SUMMARY

There has conventionally been a system in which in a game in which a content created by a user is used, a content reported by the user and report information are managed in association with each other on a server.

In such a system, the content is likely to continue to be displayed.

The present example discloses an information processing system, storage medium, information processing apparatus, and information processing method that are capable of forbidding a content and the like to be seen from the user.

The present example may have the following features (1) to (17), for example.
(1) An example configuration of an information processing system according to the present example is an information processing system comprising: a server; and a plurality of information processing terminals configured to connect to the server. The server is configured to store a state in a first virtual space in which a plurality of objects are arranged, update the stored state in the first virtual space based on a state of the objects updated based on operation inputs performed by users on the plurality of information processing terminals, and store region information indicating at least one first user region and first user information indicating a first user in association with each other, wherein the at least one first user region is a first range in the first virtual space set based on an operation input performed by the first user on a first one of the plurality of information processing terminals. A second one of the plurality of information processing terminals is configured to generate a second virtual space in which the objects are arranged, based on the state in the first virtual space stored in the server, update a position of at least a virtual camera in the second virtual space based on an operation input performed by a second user on the second information processing terminal, set a second range in the second virtual space related to the region information stored in the server, as at least one second user region, designate one of the second user regions as a designated user region based on an operation input performed by the second user, and when at least the virtual camera is located outside the designated user region, render an image of the second virtual space based on the virtual camera by a rendering process including a first effect of hiding at least a portion of the objects arranged in the designated user region.

With the configuration of (1), the image of the second virtual space can be rendered such that a least a portion of objects arranged inside a designated user region are hidden from the user, based on the user's operation input that designates the designated user region. Therefore, the user can continue to play a game without seeing the portion of the objects.
(2) In the configuration of (1), the second information processing terminal may be configured to move a player character from the outside of the designated user region to the inside of the designated user region in the second virtual space based on an operation input performed by the second user.

With the configuration of (2), the movement range of a player character can be prevented from being reduced due to designation of a designated user region.
(3) In the configuration of (1) or (2), the rendering process may include, when the virtual camera is located inside the designated user region, rendering the image of the second virtual space in a state in which at least the objects that have been hidden by the first effect are not hidden by the first effect.

With the configuration of (3), because a portion of objects hidden from the outside of a designated user region are rendered so as not to be hidden from the inside of the designated user region, obstruction of game play can be reduced to the extent possible.
(4) In the configuration of (3), the rendering process may include, when the virtual camera is located outside the designated user region, rendering the image of the second virtual space in a state in which the entire designated user region is hidden by the first effect, and when the virtual camera is located inside the designated user region, rendering the image of the second virtual space in a state in which the inside of the designated user region is not hidden by the first effect.

With the configuration of (4), even when a designated user region is entirely hidden from the outside, then if the designated user region is rendered so as not to be hidden from the inside, obstruction of game play can be reduced to the extent possible.
(5) In the configuration of any one of (1) to (4), the rendering process may include, when the virtual camera is located inside the designated user region, rendering the image of the second virtual space in a state in which the outside of the designated user region is not hidden by the first effect.

With the configuration of (5), because the outside of a designated user region is rendered so as not to be hidden by the first effect, obstruction of game play can be reduced to the extent possible.
(6) In the configuration of any one of (1) to (5), the rendering process may include, when at least the virtual camera is located outside one of the second user regions that is not designated as the designated user region, rendering the image of the second virtual space in a state in which the inside of the one of the second user regions is not hidden by the first effect.

With the configuration of (6), the designated user region and the non-designated user region can be distinguished from each other by the display form.
(7) In the configuration of any one of (1) to (6), the rendering process may include rendering the image of the second virtual space with a first transparency lower than a second transparency by the first effect.

With the configuration of (7), because the rendering process is executed using the first effect of rendering the image of the second virtual space with a relatively low transparency, at least a portion of objects arranged inside the designated user region can be easily hidden.
(8) In the configuration of (7), the rendering process may include, when at least the virtual camera is located outside one of the second user regions that is not designated as the designated user region, rendering the image of the second virtual space in a state in which the inside of the one of the second user regions has a transparency higher than the first transparency.

With the configuration of (8), the designated user region and the non-designated user region can be distinguished from each other by the set transparency.
(9) In the configuration of any one of (1) to (8), the second information processing terminal may be configured to limit updating of a state of the objects arranged in the second user region based on an operation input performed by the second user.

With the configuration of (9), for even objects arranged in a region in which a state of objects cannot be updated, the image of the second virtual space can be rendered such that at least a portion of the objects are hidden.
(10) In the configuration of (9), the second information processing terminal may be configured to set the second user region as the designated user region based on an operation input performed by the second user on the objects arranged in a range of the second user region.

With the configuration of (10), the operation of setting the designated user region can be facilitated.
(11) In the configuration of (10), the server may be configured to update the state in the first virtual space based on a designated object arranged based on an operation input performed by the first user, and store the designated object, the region information indicating the first user region, and the first user information in association with each other, wherein a range in the first virtual space set based on the arranged designated object is the first user region. The second information processing terminal may be configured to set the designated user region by setting a range provided by the designated object related to the second user region as a range to be subjected to the rendering process, based on an operation input performed by the second user on an object arranged in a range of the second user region.

With the configuration of (11), the operation of setting the designated user region can be facilitated.
(12) In the configuration of any one of (1) to (11), updating of the state of the objects based on which the state in the first virtual space is updated may include at least one of arranging the objects based on the user's operation input, removing the objects based on the user's operation input, changing texture of the objects based on the user's operation input, and embedding information related to the objects based on the user's operation input.

With the configuration of (12), arrangement of an object in the first virtual space, removal of an object from the first virtual space, changing of texture of an object tin the first virtual space, and embedding of information related to an object in the first virtual space can be performed based on the user's operation input.
(13) In the configuration of any one of (1) to (12), a third one of the plurality of information processing terminals may be configured to generate a third virtual space in which the objects are arranged, based on the state in the first virtual space stored in the server, set a range in the third virtual space related to the region information stored in the server as at least one third user region, and even when the second information processing terminal designates the second user region corresponding to one of the third user regions as the designated user region, render an image of the third virtual space in a state in which the objects arranged inside the third user region corresponding to the designated user region are not hidden by the first effect.

With the configuration of (13), in the case in which users other than the user that has set the designated user region have no problems or when the designated user region has been wrongly set, game play performed by those other users can be prevented from being obstructed.
(14) In the configuration of any one of (1) to (13), a third one of the plurality of information processing terminals may be configured to generate a third virtual space in which the objects are arranged, based on the state in the first virtual space stored in the server, update a position of at least a virtual camera in the third virtual space based on an operation input performed by a third user on the third information processing terminal, set a range in the third virtual space related to the region information stored in the server as at least one third user region, and when the second information processing terminal designates the second user region corresponding to one of the third user regions as the designated user region, and at least the virtual camera is located outside the third user region corresponding to the designated user region, render an image of the third virtual space based on the virtual camera, by a rendering process including the first effect of hiding at least a portion of the objects arranged inside the third user region.

With the configuration of (14), other users using the same virtual space can also continue to play a game without seeing objects arranged in the designated user region.
(15) In the configuration of any one of (1) to (14), the rendering process may include, when the virtual camera is located outside the designated user region and a player character is arranged inside the designated user region, and at least a portion of the player character is hidden by the first effect, rendering the image of the second virtual space based on the virtual camera by displaying the player character in a manner that allows at least a contour of the hidden portion of the player character to be recognized.

With the configuration of (15), the position of a player character can be recognized even inside the designated user region.

The present example may also be carried out in the forms of a storage medium, information processing apparatus, and information processing method.

According to the present example, a user can continue to play a game without seeing at least a portion of objects arranged in a designated user region set by the user.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a block diagram illustrating a non-limiting example configuration of an information processing system,

FIG. 9 is a block diagram illustrating a non-limiting example configuration of a server 102,

FIG. 10 is a diagram illustrating a non-limiting example of a game image showing a plurality of player characters PC arranged in the same game space,

FIG. 11 is a diagram illustrating a non-limiting example in which a terrain object La is generated in a game space by moving and joining a plurality of terrain objects together,

FIG. 12 is a diagram illustrating a non-limiting example in which display information Ia of a terrain object La generated by a first player character PC1,

FIG. 13 is a diagram illustrating a game image showing a non-limiting example of a first stage of a first player character PC1's action of arranging a first region setting object A1 in a game space,

FIG. 14 is a diagram illustrating a game image showing a second stage of a first player character PC1's action of arranging a first region setting object A1 in a game space,

FIG. 15 is a diagram illustrating a non-limiting example of a game image in a state in which a first player character PC1 is located in a first region R1,

FIG. 16 is a diagram illustrating a non-limiting example of a game image in which a second player character PC2 is located in a first region R1,

FIG. 17 is a diagram illustrating a non-limiting example of a first region R1 that is set when a first region setting object A1 is set in a game space,

FIG. 18 is a diagram illustrating a non-limiting example of a shape of a first region R1,

FIG. 19 is a diagram illustrating a non-limiting example of a game image in which an array of terrain objects L is provided in a first region R1,

FIG. 20 is a diagram illustrating a non-limiting example of a game image in which an array of terrain objects L is rendered and hidden in a first region R1,

FIG. 21 is a diagram illustrating a non-limiting example of a game image in which a silhouette of a second player character PC2 arranged in a first region R1 is displayed,

FIG. 22 is a diagram illustrating a non-limiting example of a game image in which when a virtual camera is moved into a first region R1, the inside of the first region R1 is rendered so as to be seen,

FIG. 23 is a diagram illustrating a non-limiting example of a game image in which the outside of a first region R1 is rendered so as to be hidden from the inside of the first region R1,

FIG. 24 is a diagram illustrating a non-limiting example of a data area set in a DRAM 85 of a game system 1,

FIG. 25 is a flowchart illustrating a non-limiting example of a game process that is executed in a game system 1,

FIG. 26 is a subroutine indicating a non-limiting example of a player character control process in step S123 of FIG. 25,

FIG. 27 is a subroutine illustrating a non-limiting example of a report process in step S147 of FIG. 26,

FIG. 28 is a subroutine indicating a non-limiting example of an other-player character control process in step S124 of FIG. 25,

FIG. 29 is a diagram illustrating a non-limiting example of a data area set in a storage section 105 of a server 102,

FIG. 30 is a flowchart illustrating a non-limiting example of the first half of a process executed in a server 102, and

FIG. 31 is a flowchart illustrating a non-limiting example of the second half of a process executed in a server 102.

### DETAILED DESCRIPTION OF NON-LIMITING EXAMPLE EMBODIMENTS

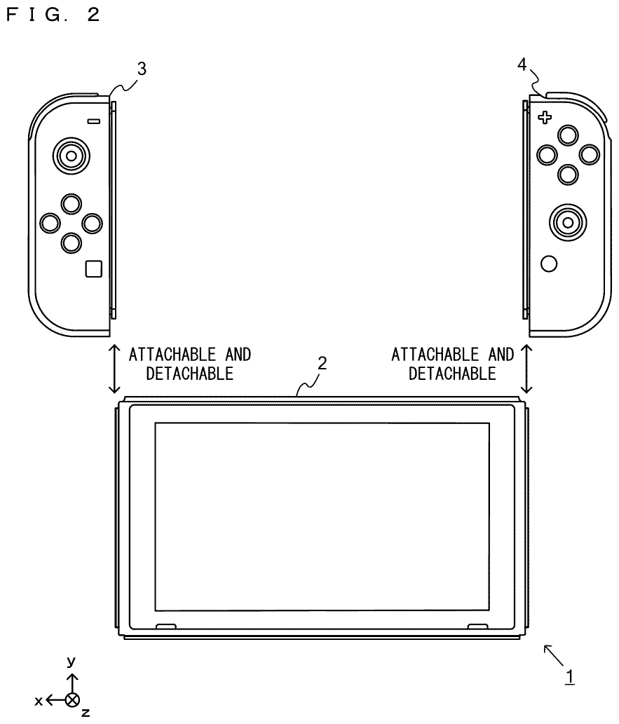

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

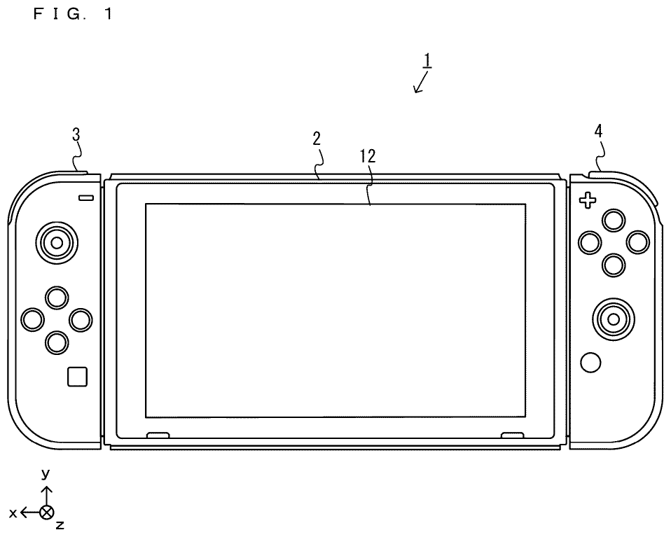

As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

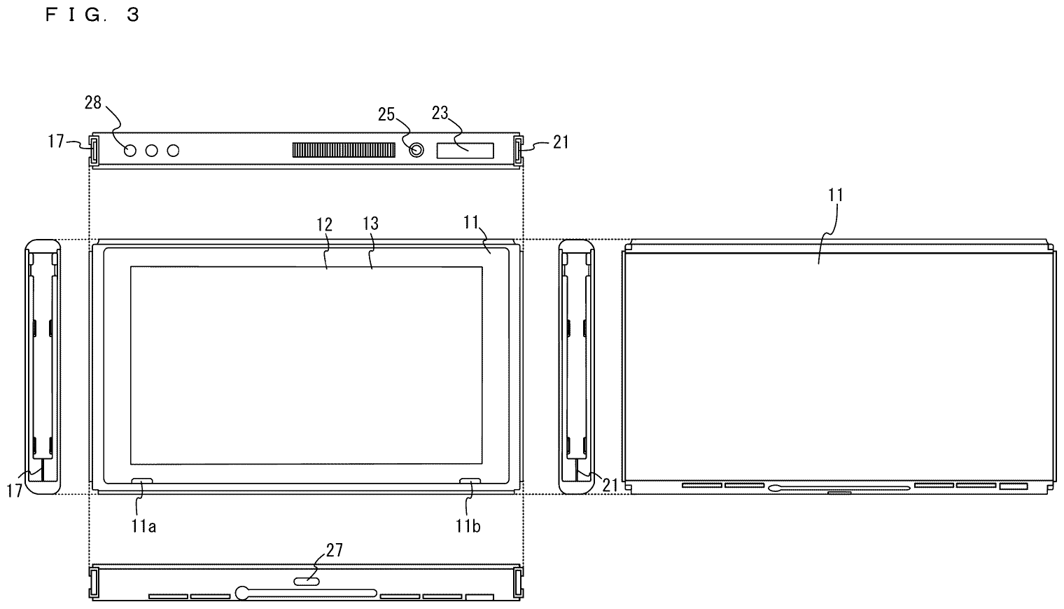

As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

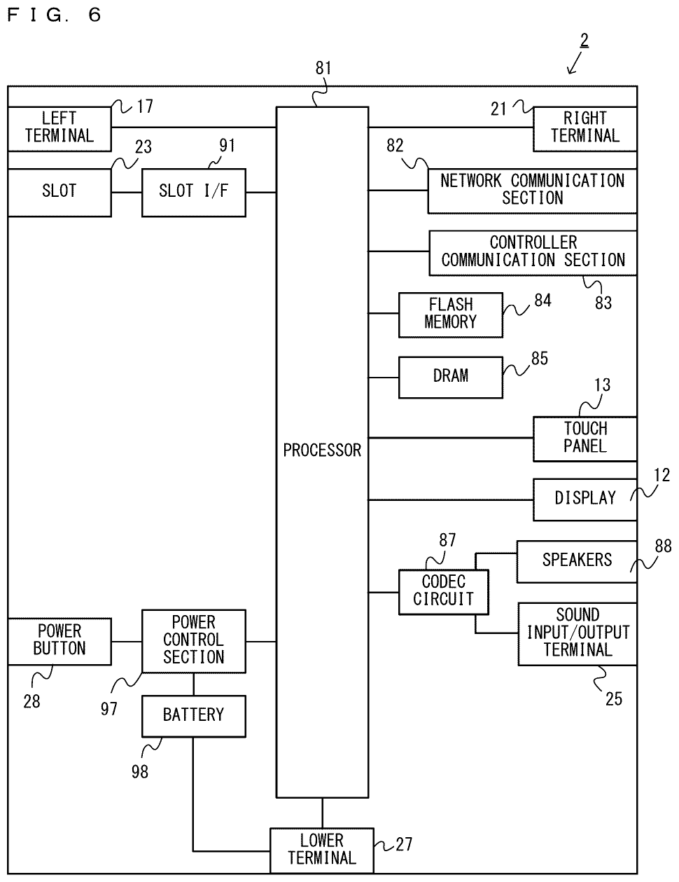

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

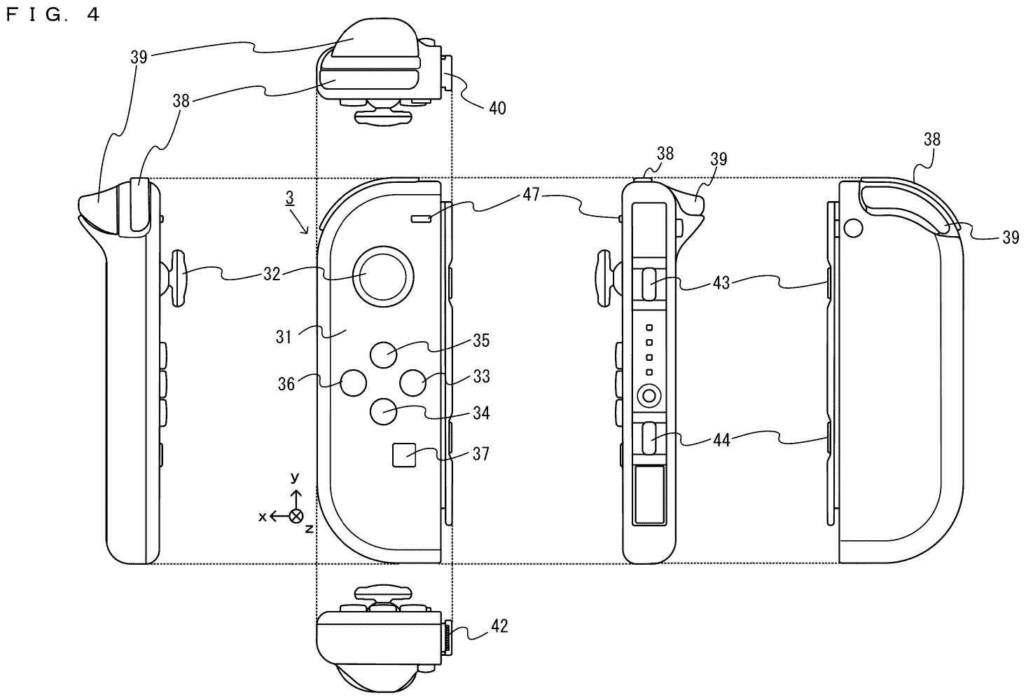

As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

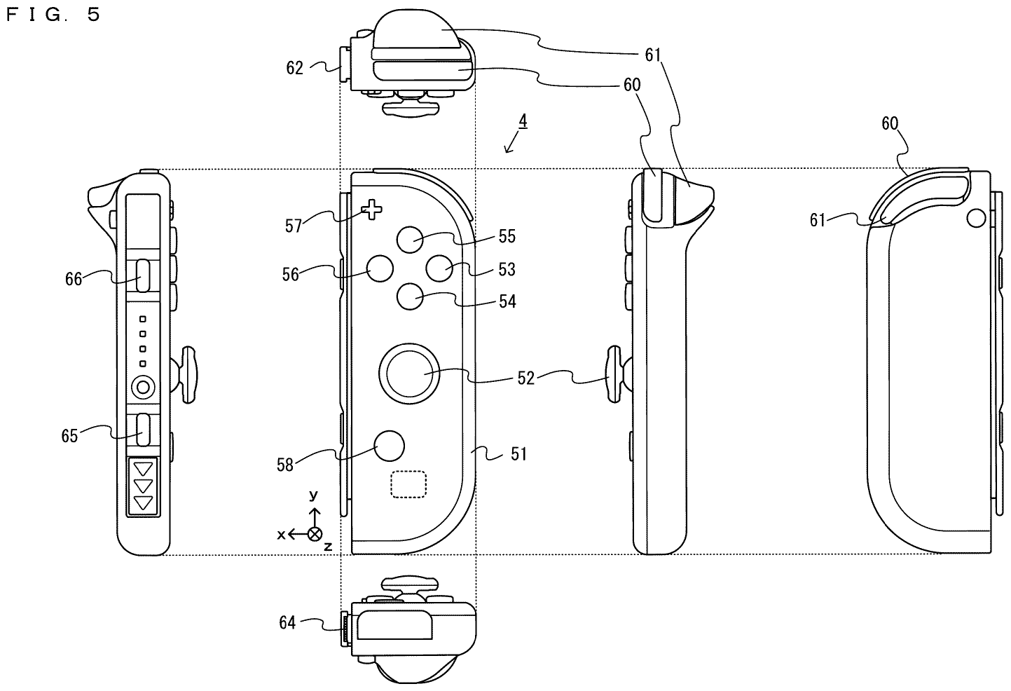

As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to provisionally store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is for controlling the input and output of audio data to and from the speakers 88 and the sound input/output terminal 25.

The main body apparatus 2 includes a power processor 97 and a battery 98. The power processor 97 is connected to the battery 98 and the processor 81. Further, although not illustrated, the power processor 97 is connected to components of the main body apparatus 2 (specifically, components that receive power supplied from the battery 98, the left-side terminal 17, and the right-side terminal 21). Based on a command from the processor 81, the power processor 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

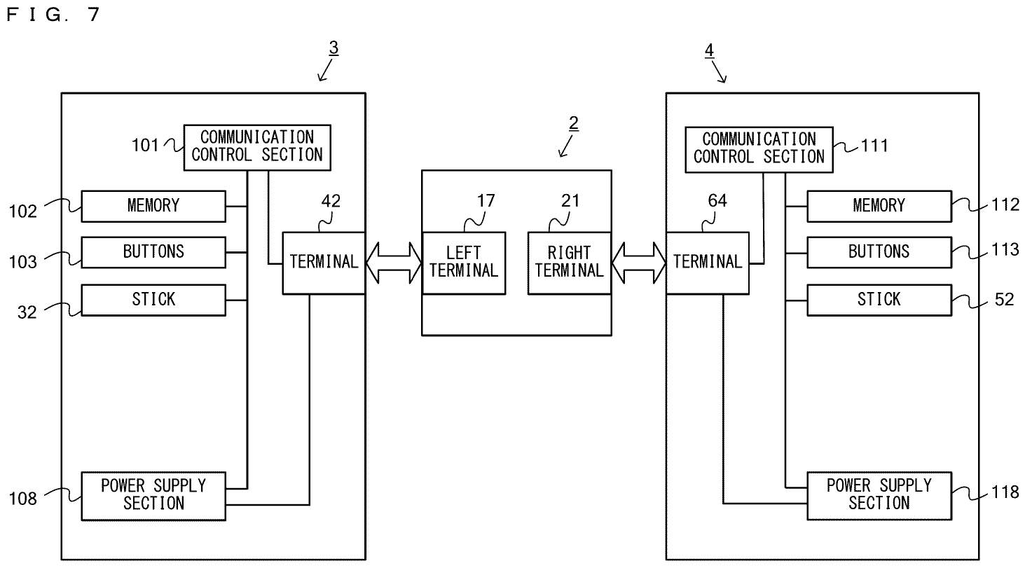

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a game space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs actions in the game space according to the user's operation performed using the operation buttons and sticks.

In the present example, a game in which a plurality of users are allowed to operate respective corresponding player characters so that the player characters perform actions in the same game space can be executed. The game is implemented by a plurality of users utilizing systems in a plurality of forms. As a first example, a game is implemented by a plurality of users operating respective player characters using respective game systems 1, and utilizing an information processing system (e.g., an information processing system in which a plurality of main body apparatuses 2 communicate with each other through a network) in which the network communication section 82 of each game system 1 performs communication through a network using the first communication form. As a second example, a game is implemented by a plurality of users operating respective player characters using respective game systems 1, and utilizing an information processing system (e.g., an information processing system in which a plurality of main body apparatuses 2 directly communicate with each other) in which the network communication section 82 of each game system 1 performs direct communication using the second communication form. As a third example, a game is implemented by inputting operation data produced by a plurality of users operating the left controller 3 and/or the right controller 4 into a single main body apparatus 2, and controlling each user's player character in the same game space using the single main body apparatus 2. In the present example, although, a system having any of the embodiments may be used, an example in which a game is implemented using an information processing system of the first example is used below.

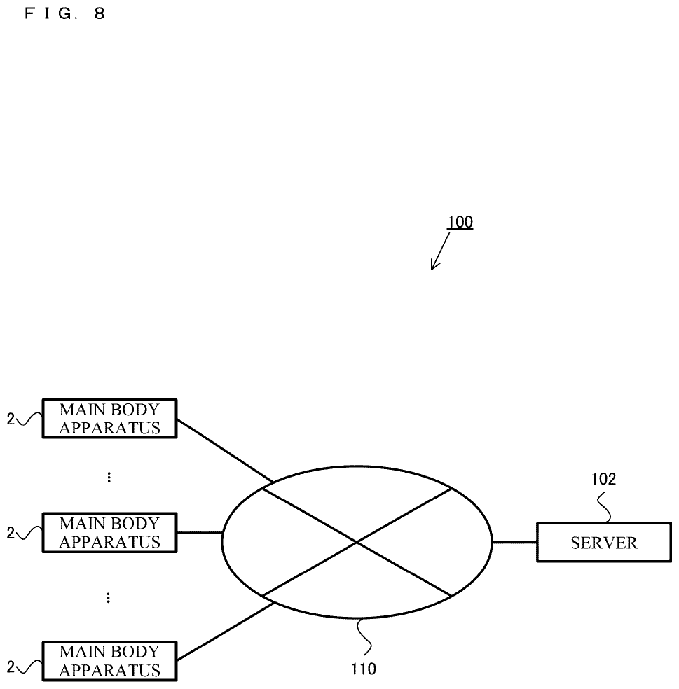

An information processing system of the first example that includes a plurality of game systems 1 and the server 102 will be described with reference to FIG. 8.

As illustrated in FIG. 8, the plurality of game systems 1 (main body apparatuses 2) and the server 102 are connected together through a network 110 to form an information processing system 100. The game system 1 is configured to be able to connect to the network 110 by the above first communication form using wireless or wired communication, and together with the server 102, forms a client-server system. For example, the game system 1 can execute a predetermined application (e.g., a game application). In addition, by executing the predetermined application, the game system 1 can establish connection to the server 102 through the network 110 and communicate with the server 102 through the network 110.

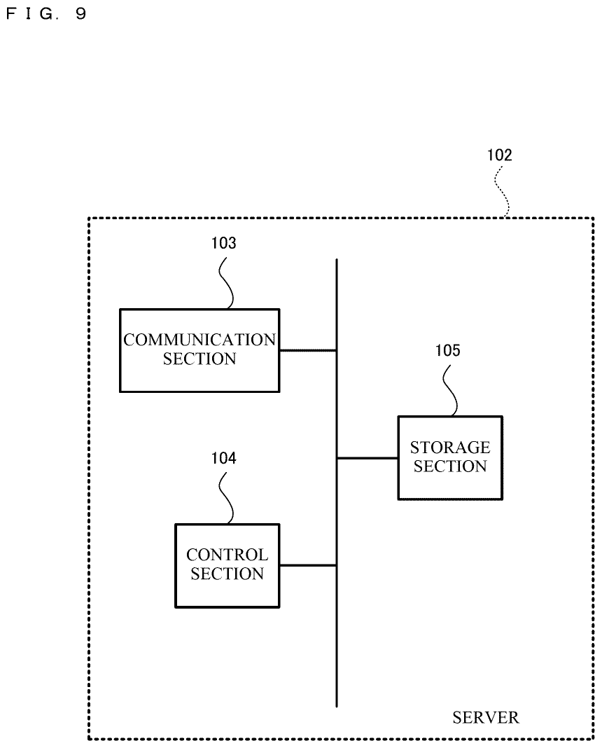

As illustrated in FIG. 9, the server 102 has a communication section 103, a control section 104, and a storage section 105. The communication section 103 communicates with the game systems 1 and the like through the network 110 by transmitting and receiving communication packets. As an example, the control section 104 performs a process of managing progression of a game played along with the game systems 1, managing a game space used in a game, managing a report from a user, managing each user's score, managing information about payment or charging, and the like. The control section 104 also establishes a communication link to the game systems 1 and the like through the communication section 103, and performs data transmission control and routing on the network 110. In addition, when a game is played along with a plurality of game systems 1 (e.g., a game in which a plurality of users operate respective corresponding player characters so that the player characters perform actions in the same game space), the control section 104 manages pairing or grouping of game systems 1 that perform the game, and data communication between the game systems 1. The storage section 105 stores a program executed by the control section 104, various types of data required for the process, various types of data required for communication with the game systems 1, and the like. It should be noted that, in the case of a system in which a predetermined log-in process is required for data exchange performed through the network or joining a game, the server may execute an authentication process to determine whether or not a user that is trying to log in is an authorized user. In addition, the server may be a single server machine or may include a plurality of server machines.

In the present example, in the information processing system 100, the game systems 1 exchange operation information through the server 102, so that a networked game in which player characters corresponding to respective users perform actions in the same game space as a shared space is played. The operation information exchanged in the networked game may be information about player characters operated by the users using controllers, information about a game space edited by the player characters' actions, details of operations themselves performed by the users operating the player characters using controllers, or other information with which game progression in the game systems 1 can be understood.

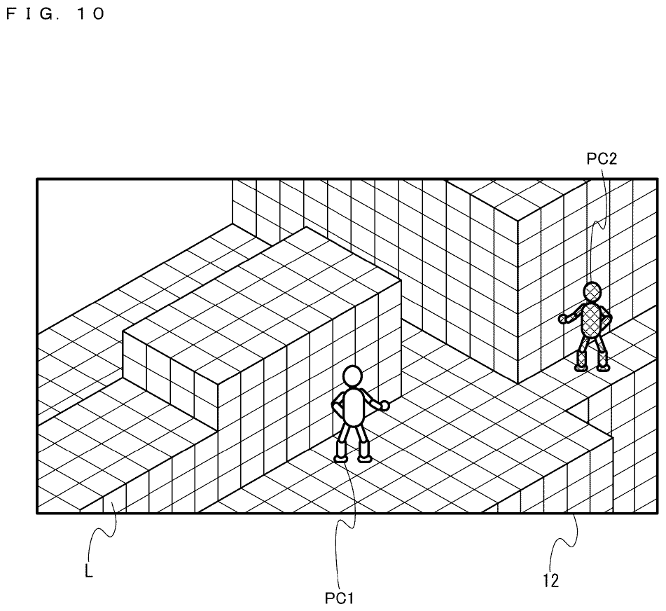

An example game process performed in the game systems 1 included in the information processing system 100 will be outlined with reference to FIGS. 10 to 23. Firstly, in the overview of the example game process, a game space used in the example game process will be outlined with reference to FIG. 10.

In FIG. 10, in the present example, a game field is constituted by a plurality of unit regions. For example, the unit regions are squares arranged in a grid pattern when the game field is viewed vertically from above. The unit regions have equal sizes. Specifically, in the case in which an x-axis and a z-axis, which are horizontal and orthogonal to each other, and a y-axis, which is vertical, are set in the game field, the game field is divided by a plurality of planes parallel to the xy plane and a plurality of planes parallel to the yz plane into squares in a grid pattern, each of which is a unit region. Thus, in the game field, unit regions are arranged side by side in the horizontal direction (specifically, the front-back direction and the left-right direction) in the game space.

A shape of the game field is determined using terrain objects L (pieces) as units. Terrain objects L are elements constituting the game field. The shape of the game field can be changed by performing editing such as movement, addition, or removal on a terrain object L by terrain object L basis. A size of a terrain object L in the horizontal direction of the game space is equal to that of a unit region, and a length of a terrain object L in the vertical direction of the game space is equal to a length of a unit region in the horizontal direction of the game space. It should be noted that the game field may include a plurality of sections including a plurality of unit regions.

A terrain object L has a rectangular cuboid shape (more specifically, a cubic shape). A game field is constituted by terrain objects L arranged in a grid pattern in the game space. As an example, in the present example, in the game system 1, a parameter related to a terrain object L is set for a coordinate point set in the game space, and for each of a plurality of coordinate points, a parameter indicating whether or not a terrain object L exists at that coordinate point is stored. Thus, in the game system 1, a shape constituted by a plurality of terrain objects L in the game space can be specified by managing whether or not a terrain object L exists at each coordinate point in the game space (e.g., storing the parameter for each coordinate point). It should be noted that the surface of a terrain object L may have roughness, and may have a rounded corner.

In another example, in the game system 1, a parameter may be set for each terrain object L existing in the game space. The parameter set for each terrain object L indicates at least the position of the terrain object L in the game space. Thus, in the game system 1, by managing the position of each terrain object L in the game space (e.g., storing the parameter for each terrain object L), a shape constituted by a plurality of terrain objects L in the game space (the shape of a game field) can be specified.

In the present example, a terrain object can be edited such that a state of the terrain object is updated, by the player character PC performing a predetermined action based on the user's operation, for example. Examples of the updating of a state of a terrain object include arrangement of a new terrain object in the game space, removal of a terrain object that has already been arranged in the game space, changing of an appearance (texture or shape) of a terrain object that has already been provided in the game space, and embedding of information in a terrain object that has already been arranged in the game space.

The editing of a terrain object includes generation of a new terrain object that appears in the game space by moving and joining terrain objects L that have been arranged in the game space together or newly moving and joining terrain objects together. The editing of a terrain object also includes updating of the generated terrain object by moving the generated terrain object, changing the appearance or property of the generated terrain object, or newly joining another terrain object to the terrain object, and the like. In the present example, a player character PC that has edited a terrain object is referred to as an “editor”. In the present example, the number of objects that are subjected to a single occasion of the predetermined action performed by the player character PC is one of a plurality of objects (terrain objects). Alternatively, a plurality of objects may be simultaneously subjected to a single occasion of the predetermined action performed by the player character PC.

The editing performed by moving a terrain object includes at least an embodiment in which a parameter of the terrain object is updated, as described below. As an example, in the case in which a parameter related to a terrain object is set at a coordinate point in the game space, the parameter at the coordinate point in the game space is updated by moving the terrain object, and information about a user (player character PC) that has updated the parameter at the coordinate point using the terrain object is embedded and stored as an editor in the terrain object. As another example, in the case in which a parameter indicating a position in the game space is set for a terrain object, when the terrain object is moved and thus edited, a parameter indicating a position where the terrain object is arranged after the movement and a parameter indicating the editor are updated.

In addition, in the present example, by rewriting and updating the parameters so as to delete a portion of a plurality of terrain objects L constituting a terrain, a state of the terrain objects L can be updated such that the terrain is easily changed in the game space. In addition, likewise the case in which terrain objects L are deleted, by rewriting and updating the parameters so as to arrange terrain objects L as units, a state of terrain objects can be updated such that a terrain is easily changed in the game space. Thus, in the present example, a state of terrain objects in the game space can be easily updated by rewriting the parameters, and a state of the game space can be updated according to the updated state of the terrain objects. As a first example, when the player character PC moves or joins a portion of a terrain, the terrain is changed in the game space. As a second example, when terrain objects L are destroyed by, for example, the player character PC hitting a terrain, the terrain is changed in the game space. Thus, terrain objects function as a terrain piece or terrain block that can be used to edit a terrain in the game space.

In the present example, by rewriting and updating the parameters by embedding information in a terrain object L when the player character PC performs a predetermined action according to the user's operation, a state of the terrain object can be updated. As an example, a state of a billboard, which is a terrain object L, can be updated by embedding text information based on the user's operation in the object. The text information may be embedded in the billboard in any format. For example, the text information may be embedded by embedding text selected by the user from a plurality of existing pieces of text or embedding text arbitrarily input by the user using a software keyboard. As another example, a state of a terrain object L or another object can be updated by embedding image information (e.g., an image such as a screenshot captured in a game, and a photograph or illustration uploaded in a server) therein. In these cases, when a player character approaches the state-updated object or the user performs a predetermined operation with a player character positioned close to the object, the embedded text information or image information is displayed. As a variation, the text information or image information may be continuously displayed near the object. In addition, as a variation, letter information (arbitrary text) may be embedded and displayed at a billboard object, which is different from terrain objects L. Furthermore, as a variation, audio information may be embedded in terrain objects L and the like.

In addition, in the present example, a state of a surface of a terrain object L can be updated by rewriting and updating the parameters by changing the texture of the terrain object L according to the player character PC's predetermined action performed based on the user's operation. For example, a state of a surface of a terrain object L may be updated based on texture created by the user in a game, or may be updated by uploading texture created outside a game to a server.

In addition, in the present example, other objects different from terrain objects L may be arranged in the game space. In addition, the above other objects may be able to be edited based on the player character PC's predetermined action in the game space. In that case, for the above other objects, the parameters corresponding to each object may include data indicating the editor. As an example of the above other objects, a decorative object that is a content which the player character PC can wear or be equipped with in the game space can be edited based on the player character PC's predetermined action.

For example, the player character PC generates a decorative object that the player character PC can wear on its head, and arranges the decorative object on a terrain in the game space, according to the user's operation input. Here, the user is allowed to edit the decorative object by switching and editing decorative parts having a plurality of types of parts, to generate and cause various decorative objects to appear in the game space.

In addition, decorative objects arranged in the game space can be picked up by another player character PC according to another user's operation, received from another player character PC, or duplicated into the same decorative object, which can be taken out, and then can be worn by the player character PC on its body or stored in itself. In addition, the position, orientation, shape, appearance, property, size, and the like of a decorative object can be changed and edited by the player character PC according to the user's operation, and the shape and texture of the decorative object are also updated based on the change.

In addition, in the present example, a terrain in the game space may be constituted by a plurality of types of terrain objects having different properties or appearances. In that case, the parameters may include any data that can specify the properties or appearance of an arranged terrain object L. For example, the parameters may include data that can specify properties including a material such as sand, rock, soil, or ice, brittleness, joinability to other objects, or the like, or data that can specify appearance indicating texture or the like used for a terrain object, or the like, whereby the states of a plurality of types of terrain objects can be set. In that case, by a player character PC editing the properties or appearance of a terrain object, the parameters for the edited terrain object may be able to be updated.

A terrain object may be able to be joined to another neighboring terrain object, so that an integrated terrain object is edited. For example, by the player character PC performing a predetermined action, a plurality of terrain objects that are a target of the action may be joined together to be integrated. In that case, the parameters may include data that can be used to determine whether or not terrain objects have been joined together to be integrated or the like, thereby making it possible to set whether or not a terrain object is joined to and integrated with another terrain object. In the present example, the editing of a terrain object includes editing performed by the terrain object being joined to another terrain object to form an integrated object, and editing performed by removing the integration. When a terrain object is joined to another terrain object adjacent thereto to form an integrated object, even if no object is not present under at least one of these terrain objects that is not supported from the bottom, but another one of these terrain objects is supported from the bottom, the object that is not supported from the bottom does not drop, so that the positional relationship (arrangement) can be maintained.

In addition, when a terrain object L is destroyed by the player character PC to be removed from the game space, an item corresponding to the terrain object L (e.g., a card item indicating a material for the terrain object L) may be able to be caused to appear in the game space. In the present example, the changing of a state of the game space and the editing of a terrain object may include removing the terrain object L from the game space to cause the item to appear. In addition, a terrain object may be able to be generated from the item, and the editing of a terrain object may include arrangement of a terrain object generated from the item in the game space.

In addition, other states of a terrain object may be able to be edited. For example, the editing of a terrain object may include changing a shape or type of the terrain object itself arranged in the game space, changing or rotating the orientation of the terrain object arranged in the game space, changing the durability or properties (movability, joinability, or the like) of the terrain object arranged in the game space, and the like. In the present example, the parameters may be used to identify these states, and the parameters corresponding to a terrain object may be updated by rewriting the parameter.

In the present example, a game space constituted by a plurality of terrain objects L is used to perform a game in which a plurality of users operate respective corresponding player characters PC so as to cause the player characters PC to perform actions. For example, in an example illustrated in FIG. 10, a first player character PC1 and a second player character PC2 are arranged on a terrain constituted by a plurality of terrain objects L. The first player character PC1 corresponds to the user of a game system 1 (hereinafter referred to as a first user), and performs actions in the game space according to the first user's operation of the left controller 3 and/or the right controller 4 of the game system 1. The second player character PC2 corresponds to the user of another game system 1 (hereinafter referred to as a second user), and performs actions in the same game space as that in which the first player character PC1 is arranged, according to the second user's operation of the left controller 3 and/or the right controller 4 in the another game system 1.

A state in a game space can be changed by a plurality of users operating and causing respective player characters PC to edit a terrain object L, which is an example content in the game space. For example, by causing the first player character PC1 to perform an action based on the first user's operation input, a terrain object L corresponding to a position in the game space corresponding to the action can be moved, a terrain object L corresponding to a position in the game space corresponding to the action can be deleted, or a terrain object L can be newly arranged at a position in the game space corresponding to the action, or a generated terrain object can be duplicated. In addition, by causing the second player character PC2 to perform an action based on the second user's operation input, a state in the same game space can be changed as in the case of the first character player PC1.

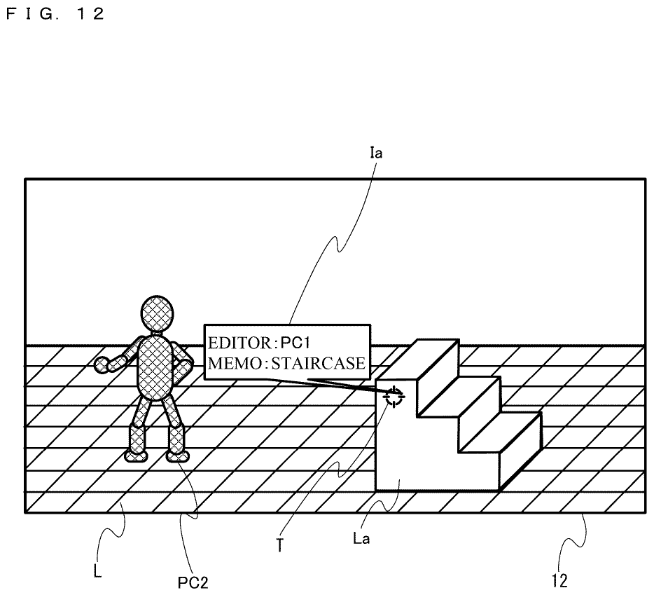

In the present example, the parameters corresponding to each terrain object that has been edited may include data indicating an editor (arranger). Here, the editor indicates a player character PC that has edited a terrain object in the game space last. Information about the editor (e.g., the ID of the player character PC) of a terrain object can be viewed by the editor of the terrain object according to a predetermined operation performed by a user. For example, as illustrated in FIG. 12, when a user wants to view the editor of a terrain object L, the editor of the terrain object L is displayed by aligning a displayed aiming point T with the terrain object L. In another example, an editor may be displayed by a user performing an operation instruction to view a menu screen. For example, by a user performing an operation instruction to view a menu screen with the displayed aiming point T aligned with a terrain object Lx for which the user wants to view the editor, the editor of the terrain object L may be displayed on the menu screen.

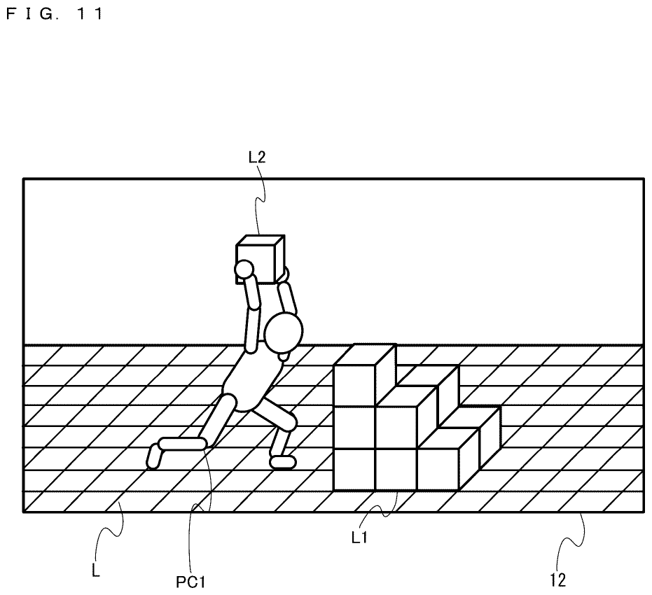

As illustrated in FIG. 11, a staircase-like array of terrain objects L1 is generated by moving a plurality of terrain objects. Furthermore, when a first player character PC1 performs a predetermined action on the staircase-like array of terrain objects L1, the plurality of terrain objects L1 are joined together to generate a staircase-like terrain object La, which is a single mass of terrain objects (see FIG. 12). The first player character PC1 can raise and move, or store, the terrain object La by performing a predetermined action. Thereafter, by the first player character PC1 moving in the game space while raising or storing the terrain object La, the terrain object La is moved together with the first player character PC1, so that the terrain object La can be arranged on or joined to another object by a predetermined action. Here, that the first player character PC1 stores an object means that the first player character PC1 is allowed to carry an item or the like representing the object without holding or wearing the object, for example. At this time, the stored object may not be displayed in the game space. The stored object can be arranged or used (including wearing and holding) in the game space according to the first user's operation input, basically in appropriate situations. As an example, for example, the first player character PC1 may store an object by putting the object into a container such as a pouch or item box. It should be noted that such a container may not be displayed. In addition, the container such as a pouch or item box may not exit in the game space, and only the function of storing an object may exist.

It should be noted that the terrain objects La and L1 may be a portion of terrain objects L that are previously arranged in the game space during the start of a game, may be previously arranged on other terrain objects L, may be arranged at a predetermined position when a player level reaches a predetermined level or a predetermined acquisition condition is satisfied, e.g., a mission is achieved, or may be arranged when another character drops the object, or another character is beaten.

As illustrated in FIG. 12, when the aiming point T is displayed and aligned with the terrain object La, so that the terrain object La is selected as an object to be displayed, display information Ia indicating that the first player character PC1 is the editor of the terrain object La is displayed. In addition, in the present example, a memo indicating text information that has been stored by the editor using the function of storing a letter string possessed by the terrain object La is included in the display information Ia and displayed. For example, in the example of FIG. 12, the display information Ia displays and shows that the first player character PC1, which is an editor, has stored, in the terrain object La, text information such as “staircase” or “free to use” as a memo. It should be noted that the display information Ia may be displayed when the first player character PC1 is close to the terrain object La, in which the display information Ia has been set, to some extent, or when the first player character PC1 sits on the terrain object La, in which the display information Ia has been set.

In the present example, another player character can perform an action of joining another terrain object L2 to the terrain object La, for which the first player character PC1 is displayed as the editor, so that the terrain object L2 is joined to the terrain object La. In this case, the another player may be displayed as the editor of a portion of the resultant terrain object corresponding to the newly joined terrain object L2. The editor of a portion of the resultant terrain object corresponding to the original terrain object La may still be the first player character PC1. Thus, in the present example, instead of only a single editor being registered for a mass of terrain objects including the terrain object La and the terrain object L2 joined thereto, an editor may be registered for each terrain object included in the mass of terrain objects. In another example, when the terrain object L2 is joined to the terrain object La by another player character's action, it may be considered that a mass La of terrain objects (regarded as a single terrain object La) is newly generated by the terrain object L2 being joined to the terrain object La, and only the another player character may be registered as the editor of the terrain object La.

In addition, in the present example, when a terrain object has been edited a plurality of times, a player character that has edited the terrain object last may be set as the editor of the terrain object. In addition, other objects different from terrain objects may be able to be edited based on a player character PC's predetermined action in the game space. In that case, for other objects that have been edited, the parameters corresponding to each object may include data indicating an editor or text information.

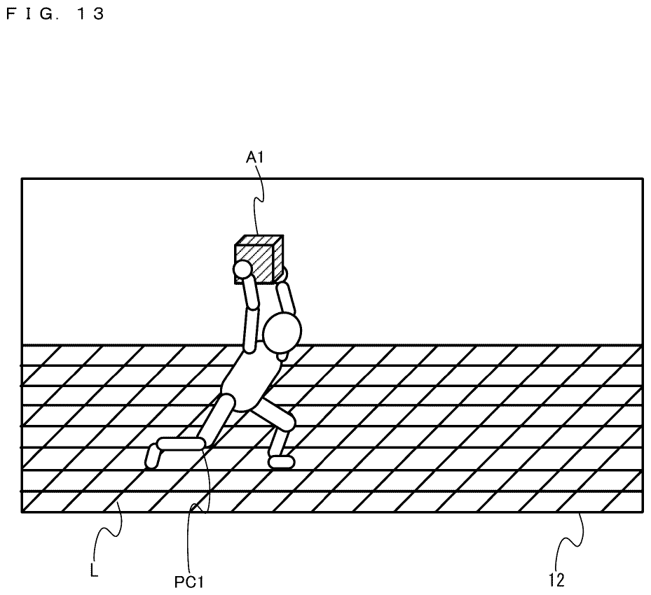

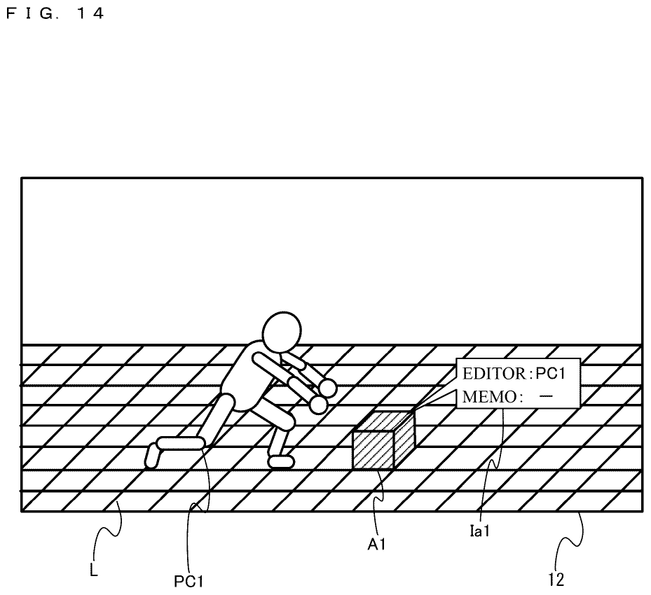

In addition, in the present example, a state in the game space can be changed and edited by executing at least one of arrangement, movement, and removal of a particular object different from terrain objects L. An example in which the inside of a game space is changed using a region setting object that is an example of the particular object will be described below with reference to FIGS. 13 and 14.

In FIG. 13, the first player character PC1 is arranged on a ground surface (terrain objects L) in the game space, holding the first region setting object A1 with the hands thereof. The first region setting object A1 can be lifted up and moved, or stored by the first player character PC1 performing a predetermined acquisition action (e.g., an action of lifting up or storing the first region setting object A1 arranged in the game space). When the first player character PC1 moves in the game space with the first region setting object A1 lifted up or stored, the first region setting object A1 is moved together with the first player character PC1. In addition, when the first player character PC1 pushes the first region setting object A1 on a ground (terrain object L) in the game space to move the first region setting object A1 in the pushing direction in the game space, the first region setting object A1 may be moved together with the first player character PC1.

It should be noted that the first region setting object A1 may be previously arranged in the game space (on terrain objects L) during the start of a game, or may be arranged at a predetermined position when a player level reaches a predetermined level or a predetermined acquisition condition is satisfied, e.g., a mission is achieved, or may be arranged when another character drops the first region setting object A1, or another character is beaten. The first region setting object A1 may be obtained from an object that is not a region setting object. In addition, a particular object may be changed to the first region setting object A1 when a particular action is performed on a particular object.

In FIG. 14, the first player character PC1 performs an arrangement action of placing or throwing the first region setting object A1 carried by the first player character PC1 according to the first user's action instruction operation input. As a result, the first region setting object A1 is arranged at a position on terrain objects L constituting a ground surface in a game space based on the arrangement action according to the user's operation input, with reference to the position of the first player character PC1. As an example, when the first player character PC1 performs an arrangement action of placing the first region setting object A1 carried by the first player character PC1, the first region setting object A1 is placed and arranged in contact with a terrain object L that is arranged immediately in front of the first player character PC1. As another example, when the first player character PC1 performs an arrangement action of throwing the first region setting object A1 carried by the first player character PC1, the first region setting object A1 is thrown and arranged in contact with a terrain object L that is arranged at a position that is a predetermined distance (corresponding to a predetermined number of terrain objects L) away from the first player character PC1 in the front direction of the first player character PC1.

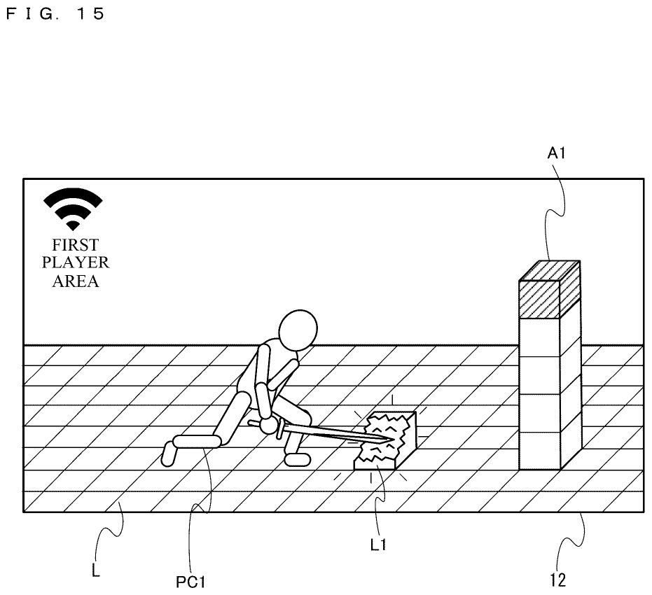

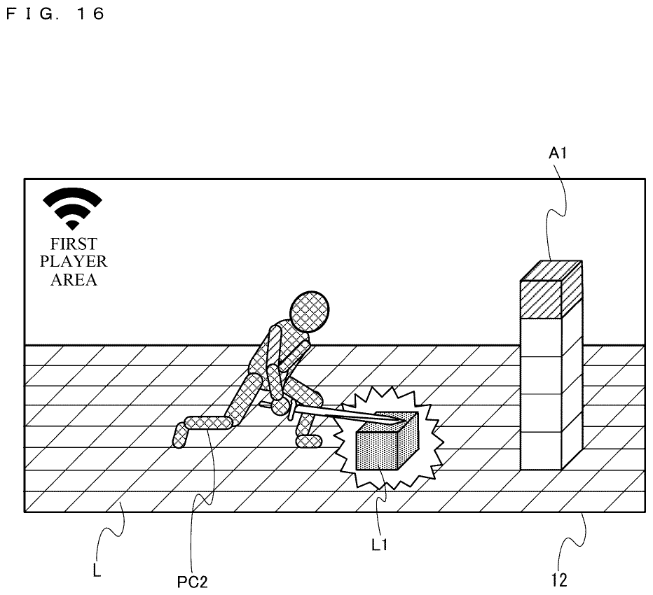

A function of the first region R1 set by arranging the first region setting object A1 in the game space will be described with reference to FIGS. 15 and 16.

The first region setting object A1 is at least one object that is associated with the first player character PC1. The first region setting object A1 has the function of, when the first region setting object A1 is arranged in a game space, setting the first region R1 associated with the first player character PC1 in the game space. Here, the association with the first player character PC1 refers to a state in which only the first player character PC1, which is one of a plurality of player characters, is allowed to use, or an effect is only given to the first player character PC1. It should be noted that as described below, the first region R1 may be displayed in a display form that can distinguish the first region R1 from other regions in the game space. In addition, in the present example, region information indicating a user region (e.g., the first region R1) set in the game space by the user and user information indicating the user that has set the user region (e.g., the first user that operates the first player character PC1) are managed in association with each other. Here, the region information includes the ID of a region setting object (e.g., the first region setting object A1), coordinate information of the region setting object in the game space, and the like. In another example, the region information may be related to the range itself of the user region, instead of the region setting object. In addition, the user information includes information such as the account ID, user name, and the like of the user.

In addition, in the present example, editing of the game space is limited in the first region R1, except for editing of the game space that is performed by the first player character PC1. For example, as described above, each player character PC is allowed to edit an object L in the game space. However, in the first region R1, editing that is performed by characters (including other player characters PC, such as the second player character PC2) other than the first player character PC1, for which the first region R1 is set, is limited, and the right to edit the game space is given to the first player character PC1. As a first example, in the first region R1, an editing right with which characters other than the first player character PC1 are forbidden to newly arrange an object (various types of objects including particular objects such as terrain objects L and region setting objects). As a second example, characters other than the first player character PC1 are forbidden to remove terrain objects L or the first region setting object A1 from the first region R1. As a third example, characters other than the first player character PC1 are forbidden to move a terrain object L or the first region setting object A1 in the first region R1. As a fourth example, characters other than the first player character PC1 are forbidden to join a plurality of objects such as terrain objects L together to form an integrated object, or remove the joining of a plurality of objects integrated together. As a fifth example, characters other than the first player character PC1 are forbidden to change the shape or type of a terrain object L itself, change or rotate the orientation of a terrain object L, or change the durability or property (movability, joinability, etc.) of a terrain object L.

Thus, by an editing right related to the game space in the first region R1 being given to the first player character PC1, a limitation is imposed on other users' changing the state of the game space in the first region R1 when the first region setting object A1 is arranged or the state of the game space in the first region R1 after having been most recently changed according to the first user's operation input. Here, the limitation on changing the state of a game space is not limited to a limitation on changing based on other users' operations, and may include a limitation on changing performed by characters (e.g., non-player characters) automatically controlled by a computer, and changing caused by phenomena other than characters' actions in a game space (collapse due to weather or shaking, and the like).

For example, the game image illustrated in FIG. 15 shows a state in which the first player character PC1 is arranged in a “first player area” in the first region R1 in which the first region setting object A1 is provided. In the first region R1, the first player character PC1 is performing an action of destroying and removing a terrain object L1. Since the right to edit a game space has been given to the first player character PC1 in the first region R1, the first player character PC1 can destroy and remove the object L1 by performing the above action.

Meanwhile, the game image illustrated in FIG. 16 shows that the second player character PC2 is arranged in the “first player area” for the first player character PC1 in the first region R1 in which the first region setting object A1 is provided. In the first region R1, the second player character PC2 is performing an action of destroying and removing the terrain object L1. In such a game space in the first region R1, the second player character PC2 does not have an editing right, and therefore, cannot destroy or remove the terrain object L1 even if the second player character PC2 performs the above action. In addition, in the present example, for even the editor (e.g., the second player character PC2) that has edited a terrain object L, a limitation is imposed on editing of the terrain object L when the terrain object L is included in a user region (e.g., the first region R1) set by a player character (e.g., the first player character PC1) other than the editor.

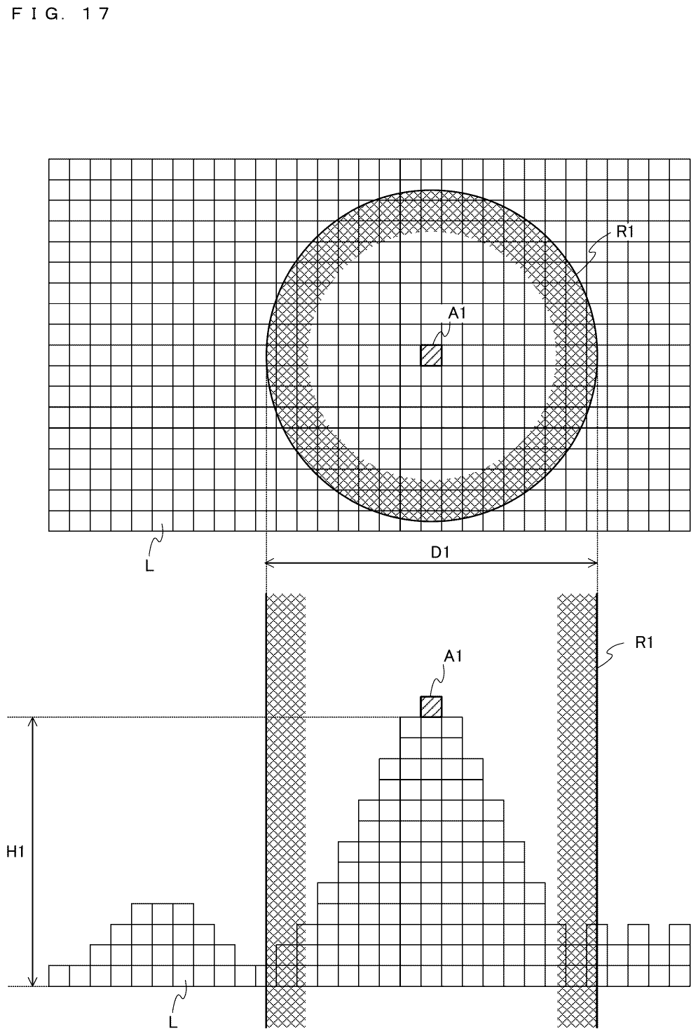

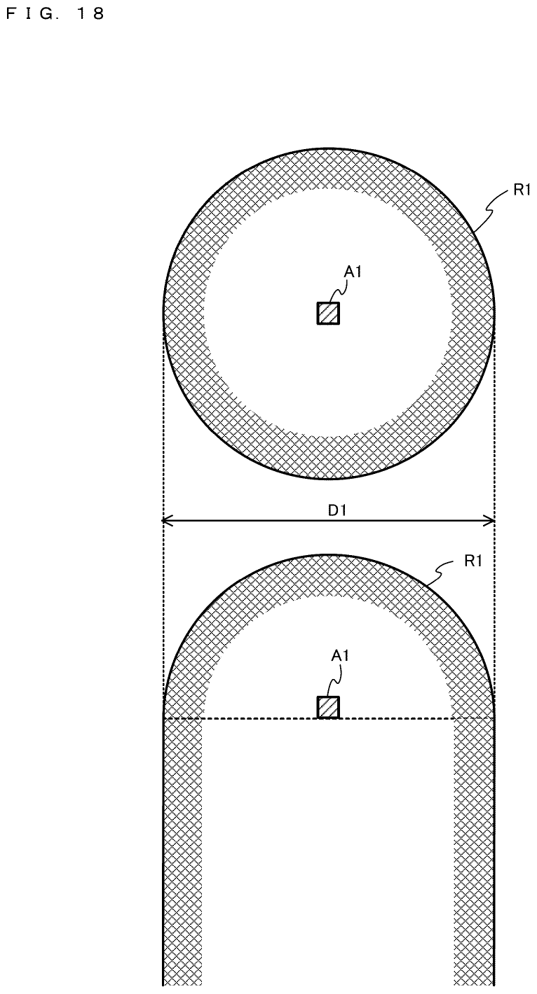

Next, an example of the position, shape, and size of a first region R1 that is set by arranging a first region setting object A1 in the game space will be described with reference to FIGS. 17 and 18. It should be noted that the upper diagram in each of FIGS. 17 and 18 is a top view of the first region setting object A1 and the first region R1 in the game space as viewed from above, and the lower diagram is a side view of the first region setting object A1 and the first region R1 in the game space as viewed in the horizontal direction.

As illustrated in FIG. 17, the first region R1 is set as a region including a position related to the horizontal direction of the first region setting object A1, and in the case in which a three-dimensional game space is set, is also set so as to include at least a portion of the first region setting object A1 arranged in the game space as viewed from above in the game space. Here, that at least a portion of the first region setting object A1 arranged in the game space is included as viewed from above in the game space means that at least a space in the game space in which the first region setting object A1 is located, a space in the game space immediately above the first region setting object A1, and/or a space in the game space immediately below the first region setting object A1 are included in a region (the first region R1). As an example, the first region R1 is formed by a cylindrical space that extends up to a limit height in the vertical direction, and the axis of which is a vertical straight line passing through the position of the first region setting object A1 in the game space. In this case, the first region R1 has a circular horizontal shape, and the first region setting object A1 is arranged at the center of the circular shape and is thus included in the first region R1. Here, the position of the first region setting object A1 may be a point that is used as a reference with which the first region setting object A1 is arranged in the game space, and that indicates the center of a lower surface of the first region setting object A1, the barycenter of the first region setting object A1, the center of an upper surface of the first region setting object A1, or the like. Thus, if the horizontal shape of the first region R1 is a circular shape the center of which is the first region setting object A1, every point on the boundary of the first region R1 has an equal distance from the position of the first region setting object A1 on the same horizontal plane. In addition, if the first region R1 has a cylindrical shape, the load of processing for determining whether or not a point is included in the region can be reduced compared to polyhedrons.

The spread in the horizontal direction of the first region R1 is set based on a height H1 in the game space at which the first region setting object A1 is arranged. As an example, in the case in which an x-coordinate in the horizontal direction, a y-coordinate in the vertical direction, and a z-coordinate in the depth direction are defined in the game space, the “spread in the horizontal direction” is the area of the first region R1 spreading in the xz-plane in the game space, and the “height in the game space” is the y-coordinate of the position of the first region setting object A1. For example, in the case in which the first region R1 has a spread in the horizontal direction around the position of the first region setting object A1 and is formed by the above cylindrical space, a radius (diameter: D1) around the position of the first region setting object A1 is set based on the height H1 in the game space at which the first region setting object A1 is arranged. For example, the spread in the horizontal direction of the first region R1 increases as the first region setting object A1 is arranged at a higher position (e.g., proportional to the height H1).

In addition, when the first region setting object A1 for setting the first region R1 is arranged in the game space, the first region setting object A1 is provided in the first region R1. In this case, by giving the above editing right, the first region setting object A1 provided in the first region R1 cannot be moved or removed by characters other than the first player character PC1, and therefore, serves as an object that is associated with the first player character PC1 and is only used by the first player character PC1.

The shape of the first region R1 may, as an example, be different from a cylindrical shape extending up to a vertical limit height in a game space, and may be that illustrated in FIG. 18 as another example. As illustrated in FIG. 18, another example shape of the first region R1 is a hemispherical-cylindrical shape that is a combination of a cylinder the axis of which is a vertical straight line in a game space that passes through the position of the first region setting object A1, and a hemisphere the center of which is located at the position of the first region setting object A1 and the pole of which is located above the first region setting object A1. Specifically, in the another example shape of the first region R1, a surface at which the cylinder and the hemisphere are combined and joined (surface indicated by a dashed line in FIG. 18) is a horizontal plane passing through the position of the first region setting object A1 (e.g., the center of the lower surface of the first region setting object A1). The first region setting object A1 is provided in the first region R1 in the vicinity of the center of the horizontal plane. Even in the case of the first region R1 having such another example shape, the radius (diameter D1) of the circle on the horizontal plane is set to be longer such that the extent in the horizontal direction of the first region R1 increases, as the first region setting object A1 is located at a higher position in the game space.

In addition, the first region R1 may have any shape that includes a horizontal plane the center of which is located at the position of the first region setting object A1, a position immediately above the position of the first region setting object A1, or a position immediately below the position of the first region setting object A1. The shape of the first region R1 may extend upward and/or downward by a predetermined distance, and may be spherical, hemispherical, conical, elliptic-cylindrical, prismatic, regular polyhedral, semiregular polyhedral, rectangular cuboidal, pyramidal, or the like, may be three-dimensional shapes such as other polyhedrons, or may be a combination of these shapes. In those cases, the first region setting object A1 for which the first region R1 is set may be arranged in the first region R1 (e.g., at the center of the first region R1 as viewed from above in the game space), or a boundary of the first region R1 (e.g., the center of an upper or lower surface of a three-dimensional shape or an apex of a three-dimensional shape), or may be arranged outside the first region R1. Thus, the position of the center of the first region R1 can be easily recognized by setting the shape of the first region R1 to a shape that includes a horizontal plane the center of which is located at a position based on the position of the first region setting object A1.

In addition, in the game space, when the first region setting object A1 is moved, the first region R1 may also be moved due to the movement. Thus, by moving the first region setting object A1 to another position, the first region R1 can be set at a position different from the position that has been set once.

In another example, a user region that is set by a user in the game space (e.g., the first region R1) may be able to be set irrespective of region setting objects (without arranging a region setting object in the game space). As an example, when a user is given a predetermined range in the game space in return for a predetermined item (e.g., in-game currency or points given to a user in a game), the range may be set as a user region for the user. As another example, each user may be previously given a respective user region.

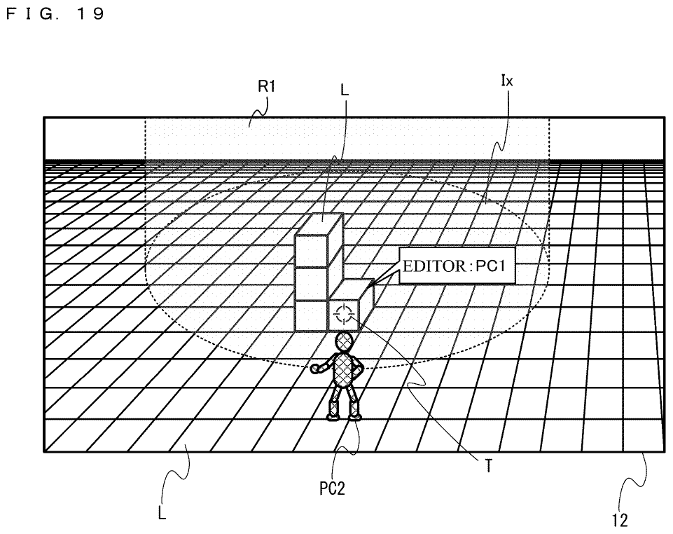

Next, the display form of the first region R1 in the game space will be described with reference to FIGS. 19 to 23.

In the present example, a user that is playing a game in the game space is allowed to report a content in the game space (e.g., a terrain object or another object arranged in the game space). For example, in the present example, terrain objects L can be edited by being arbitrarily combined and arranged in an array, by arbitrarily embedding information in the terrain object L, or by arbitrarily changing the texture of the terrain object L, potentially resulting in a content in which another user determines that the shape or arrangement of the terrain object, information embedded in the terrain object, and the texture of the terrain object are inappropriate. When such a content that has been determined to be inappropriate is arranged in the game space, it is preferable for a user that feels that the content is inappropriate that the appearance of the content should be changed.

In the present example, when a certain user reports a content that the user has determined is inappropriate, so that it is determined that the reported content is inappropriate, an object included in the reported content may be deleted, the appearance of the reported content may be returned to the default state, or information embedded in an object included in the reported content may be deleted. In addition, a user that feels that the content is inappropriate may directly edit the object to delete the content that the user has determined is inappropriate. However, when an object included in a content that has been determined to be inappropriate is arranged in a user region set by a certain user, a user that feels that the content is inappropriate does not have the editing right, and therefore, cannot delete the content that has been determined to be inappropriate. Even when the user reports the content, then if it takes time to determine that the content is inappropriate, the content that has been determined to be inappropriate remains until it is determined that the content is inappropriate.

In the present example, when it is reported that there is a content that has been determined to be inappropriate, an image process of causing at least a portion of the inside of a user region in which the content is arranged not to be seen from the reporter is executed.

In FIG. 19, an array of terrain objects has been formed by moving a plurality of terrain objects L in a first region R1 set by a first player character PC1 operated by a first user. The array of terrain objects L has been edited and configured by the first player character PC1. Here, FIG. 19 illustrates a game image that is displayed on the display 12 of a second user, and a virtual camera for generating the game image is arranged outside the first region R1. A second player character PC2 operated by the second user is arranged outside the first region R1.

The internal space of the first region R1 may be displayed in a display form that allows the firs region R1 to be distinguished from other regions in the game space even before the above reporting. As a first example, the internal space or boundary of the first region R1 may be able to be distinguished from other regions by being rendered in a color, transparency, lightness, or the like different from that of other regions (e.g., a space is rendered in a light green color). As a second example, an object belonging to the first region R1 may be able to be distinguished from other regions by being rendered in a color, transparency, lightness, or the like different from that of other objects. As a third example, the internal space of the first region R1 may be able to be distinguished from other regions by being caused to be lighter than the outside of the first region R1. For example, while no objects beyond a predetermined distance are seen in the game space outside the first region R1, objects beyond the predetermined distance may be seen in the game space inside the first region R1.

The second user that operates the second player character PC2, when feeling that an array of terrain objects L in the first region R1 is inappropriate, is allowed to report the terrain object. In the present example, a user is allowed to designate any object that is arranged in the game space (including particular objects such as region setting objects) as a matter to be reported. For example, when the second user performs an operation for reporting, an object displayed and overlaid by the aiming point T, an object arranged immediately below (at the foot of) the second player character PC2, an object arranged immediately in front of the second player character PC2, or the like is set as a matter to be reported, and report data based on the matter to be reported is transmitted to the server 102. As a first example, when a matter to be reported is arranged in a user region set by another user (e.g., an array of terrain objects L in the first region R1 illustrated in FIG. 19), report data in which a region setting object setting the user region is a matter to be reported is transmitted. It should be noted that in the first example, report data in which a range itself in which the user region has been set is a matter to be reported may be transmitted. As a second example, when a matter to be reported is arranged outside a user region set by another user, report data in which that object is still a matter to be reported is transmitted. In another example, a map image in which a predetermined icon is arranged at a position corresponding to the coordinate point of a region setting object in the game space can be displayed. In that case, by a reporter performing an operation of selecting an icon corresponding to a region setting object to be reported from a plurality of icons included in the map image, the region setting object may be able to be reported as a matter to be reported. In addition, the map image may show a range corresponding to a user region. In that case, a range itself indicated by a user region including a specified coordinate point in the map image may be able to be reported as a matter to be reported. In any of the examples, when an object for which an editor has not been set (an unsigned object, e.g., a default object arranged in the game space) or an object for which a reporter is an editor has been set as a matter to be reported, it is determined that there is an error in report, and report data may not be transmitted. It should be noted that a condition for the report error is not particularly limited. Even when an object for which an editor has not been set is set as a matter to be reported, then if the object is arranged in a user region set by another user, report data in which a region setting object setting the user region is a matter to be reported may be transmitted.

In addition, in the above first example, when a matter to be reported has been set, a region setting object (e.g., the ID of the region setting object) set as the matter to be reported is registered on a mute list in the game system 1 of the reporter. A user region set by the region setting object registered on the mute list (in the example of FIGS. 19 to 23, the first region R1) is rendered by a rendering process including the effect of hiding at least a portion of the user region, and is displayed on the display 12 in the game system 1 of the reporter. It should be noted that the mute list may be stored in the game system 1 of each reporter, or in the server 102. In addition, in the mute list, information related to a user region itself set as a matter to be reported may be stored, instead of information related to a region setting object.

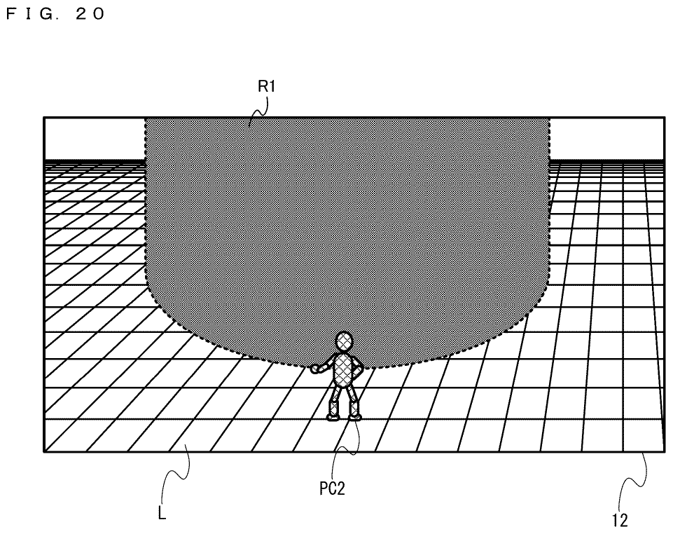

For example, when a second user reports any object arranged in the first region R1 (e.g., one terrain object L included in the above array of terrain objects L) as a matter to be reported, the region setting object A1 setting the first region R1 is registered on the mute list in the game system 1 of the second user. As a result, as illustrated in FIG. 20, when a virtual camera is located outside the first region R1, an image of the game space subjected to a rendering process including the effect of hiding at least a portion of objects arranged inside the first region R1, is generated based on the virtual camera. For example, in the present example, the effect causes the inside of the first region R1 to be rendered so as to have a transparency lower than a predetermined transparency. Typically, when the first region R1 is viewed from the outside thereof, the first region R1 is rendered using the effect of causing the entire first region R1 to be completely opaque (transparency: 0%). If the first region R1 has such a transparency that the inside of the first region R1 is not seen when viewed from the outside thereof, the first region R1 may be rendered using the effect of imparting a transparency lower than a predetermined transparency.

As illustrated in FIG. 20, the rendering process using the effect of hiding the inside of the first region R1 causes an array of terrain objects L arranged in the first region R1 to be hidden from the outside of the first region R1. Therefore, when the second user reports the array of terrain objects L as a matter to be reported, the array of terrain objects L is not displayed on the display 12 of the second user. Thus, a game image can be displayed in which a content that it has been determined is inappropriate is hidden.

In the present example, a player character is allowed to enter/exit a user region set by a region setting object according to the user's operation even when the player character does not have the editing right in the region. For example, in the example of FIG. 20, the second player character PC2 arranged outside the first region R1 is allowed to move from the outside into the inside of the first region R1. This movement of the second player character PC2 can be similarly performed in a state after reporting that the inside of the first region R1 is hidden by the above effect. Since even a player character that does not have the editing right is thus allowed to enter/exit a user region set by a region setting object, the range in which each player character is allowed to move in the game space can be prevented from being reduced.

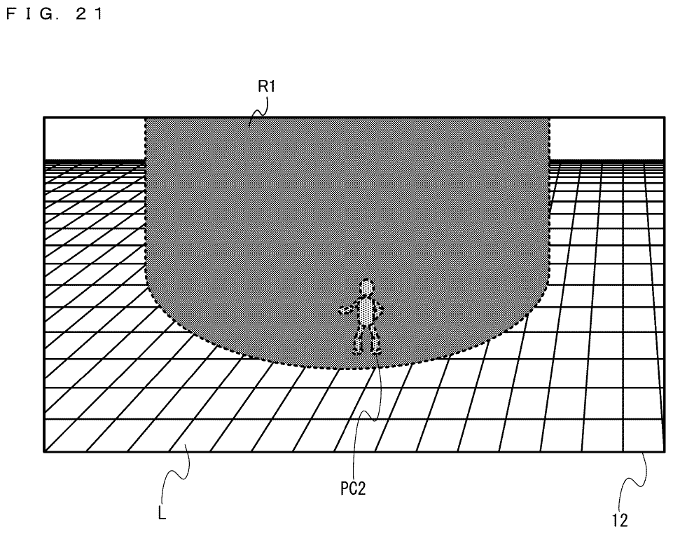

As illustrated in FIG. 21, when the second player character PC2 enters the inside of the first region R1, which is hidden by the effect, then if the virtual camera is arranged outside the first region R1, the second player character PC2 is displayed in silhouette. Here, the silhouette display is such that at least the contour of a portion of a player character hidden by the effect can be recognized. In addition to the contour, a portion of the inside of the contour may be displayed in a display form different from that provided by the effect (e.g., in a different color). As a result, even in a user region hidden by the effect, the position of a player character in the game space can be recognized. In addition, as a variation, when the second player character PC2 enters the inside of the first region R1, which is hidden by the effect, the inside of the first region R1 may be rendered so as to be seen without execution of a rendering process using the effect of hiding the inside of the first region R1.

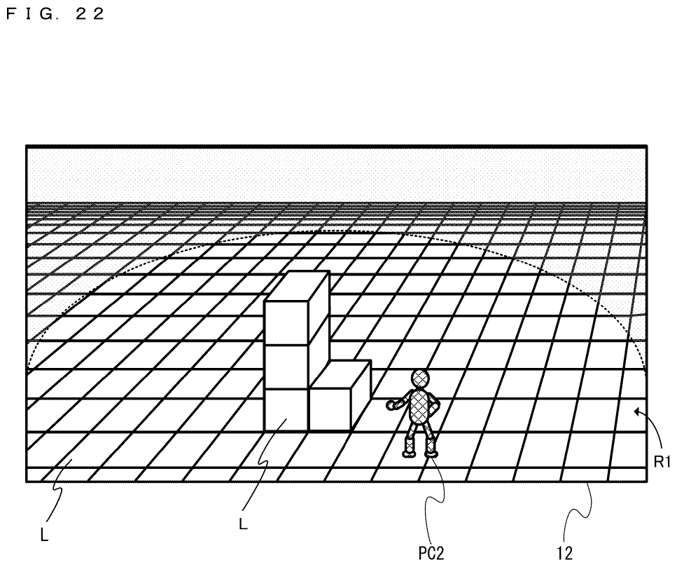

As illustrated in FIG. 22, when both the second player character PC2 and the virtual camera enter the inside of the first region R1, which is hidden by the effect, the inside of the first region R1 is rendered so as to be seen without execution of a rendering process using the effect of hiding the inside of the first region R1. In addition, when the virtual camera is located inside the first region R1, the game space outside the first region R1 as viewed from the inside of the first region R1, is rendered such that the outside of the first region R1 is seen, without execution of a rendering process using the effect. Therefore, even when the second user reports an array of terrain objects L as a matter to be reported, then if a virtual camera (viewpoint) for generating a game image is located inside the first region R1, the entire internal space of the first region R1 including a content that is the matter to be reported that the second user has determined is inappropriate and has reported, and an external space as viewed from the inside of the first region R1, are both rendered so as to be seen. As a result, when the virtual camera enters the inside of the first region R1, the spaces inside and outside the first region R1 are rendered so as to be seen, and therefore, obstruction of game play can be reduced to the extent possible.

It should be noted that when the virtual camera (viewpoint) is located inside the first region R1, the spaces inside and outside the first region R1 after the reporting may be displayed in a display form that allows the spaces inside and outside the first region R1 to be distinguished from other regions in the game space. For example, at least one of the spaces inside and outside the first region R1 and an object located inside the first region R1 may be rendered in a color, transparency, or lightness different from that of other regions and objects so as to be distinguishable.

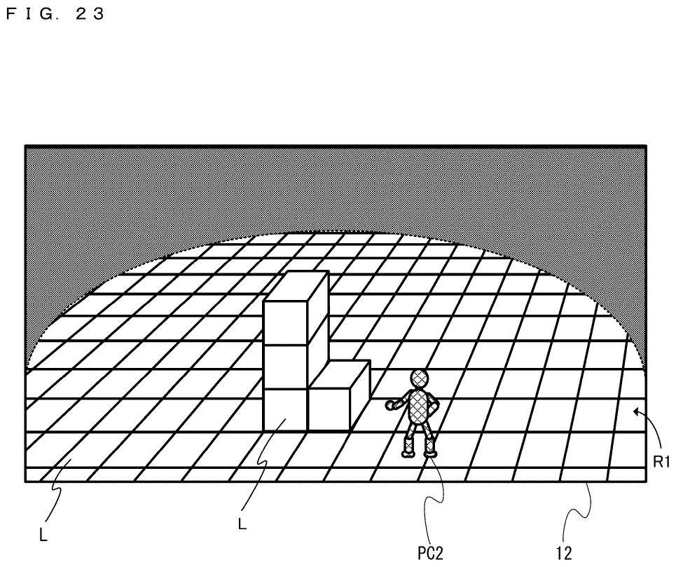

In another example, when the virtual camera is located inside the first region R1, the game space outside the first region R1 as viewed from the inside of the first region R1 may be subjected to a rendering process using the effect, and the outside of the first region R1 may be rendered to be hidden from the inside of the first region R1. For example, as illustrated in FIG. 23, when the virtual camera is located inside the first region R1, the inside of the first region R1 may be rendered to be seen, while the game space outside the first region R1 as viewed from the inside of the first region R1 may be rendered to be hidden. It should be noted that in the another example, when the second player character PC2 exits the first region R1, the inside of which is hidden by the effect, then if the virtual camera is located inside the first region R1, the second player character PC2 may be displayed in silhouette.

It should be noted that in the present example, the rendering process of hiding the inside of the first region R1 using the effect is executed only on a game image that is displayed on the display 12 of a game system 1 operated by a reporter that has reported the first region R1 as a matter to be reported. Therefore, for each user that is playing a game in the same game space, except for the reporter, a game image in which the inside of the first region R1 is not hidden by the effect (e.g., an image of the first region R1 illustrated in FIG. 19) is displayed. As a result, for a user that does not feel that an array of terrain objects L arranged inside the first region R1 is inappropriate, a game image can be directly displayed, and a game image of another user can be prevented from being affected by wrong reporting.

In another example, when a reporter reports the first region R1 as a matter to be reported, the rendering process of hiding the inside of the first region R1 using the effect may be executed on all game images of users that are playing a game using the same game space, for example. In addition, the rendering process of hiding the inside of the first region R1 using the effect may be executed on all game images of users that are playing a game using the same game space, except for the game image of a user for which the first region R1 has been set (e.g., the first user).

In addition, when a user region the inside of which is hidden by the effect (e.g., the first region R1) is moved by, for example, a region setting object (e.g., the region setting object A1) being moved as described above, the inside of the user region at the destination of the movement may be rendered to be hidden by the effect as before the movement. As a result, at least a portion of the user region that has been hidden by the effect before the movement may be caused to be seen. In that case, at least a portion of an object as a matter to be reported (e.g., an array of terrain objects L) may be caused to be seen from the reporter. However, the portion of the object that is seen departs from a user region set by another user, and is arranged at a place where the reporter has the editing right, and therefore, the reporter can delete that portion. In another example, a user region that has been hidden by the effect before the user region is moved may continue to be hidden by the effect even after the user region is moved.

In addition, in the above example, an image in which at least a portion of an object arranged in a user region is hidden is displayed by a rendering process using the effect of causing the transparency of the inside of the user region to be lower than a predetermined transparency. Alternatively, the inside of the user region may be hidden by another rendering process. For example, an image in which at least a portion of an object arranged in a user region is hidden may be displayed by executing a mosaic process on at least a portion of the user region, or a process of painting out all objects in the user region in a predetermined color (e.g., painting out in black).

In addition, in the above example, an array of terrain objects L arranged in the first region R1 is reported by the second user. The form of objects as a matter to be reported is not particularly limited. For example, a single mass of terrain objects obtained by joining an array of terrain objects L together by the first player character performing a predetermined action on the array of terrain objects L, may be a matter to be reported by the second user. Even in that case, when the joined terrain objects are arranged in the first region R1, report data in which the region setting object A1 setting the first region R1 is a matter to be reported is transmitted by reporting performed by the second user.

In addition, in the present example, when an object arranged outside a user region set by another user is set as a matter to be reported, a state (appearance or setting) of the object itself may be changed. As a first example, when UGC (text information, image information, audio information, etc.) is embedded in the object, a state of the object that is displayed on the display 12 of the reporter, or an output audio content, may be changed by deleting the information, forbidding the information to be displayed/output. As a second example, a state of the object that is displayed on the display 12 of the reporter may be changed by displaying the object in a display form indicating that the object is a matter to be reported (e.g., the appearance (texture) is changed to one indicating the material “soil”). As a third example, in the case in which an object as a matter to be reported is obtained by joining a plurality of objects together, a state of the object that is displayed on the display 12 of the reporter may be changed by forbidding one(s) of the plurality of objects for which an editor has been set to be displayed. As a fourth example, when it is determined that a report has been made on the above section including an object that is a matter to be reported, a predetermined process, e.g., changing a state in the section according to the number of times the reporting has been performed, may be executed.

In the present example, when an object (e.g., a terrain object L) arranged in the first region R1 is reported as a matter to be reported by the second user, and user-generated content (UGC) such as text information, image information, and audio information is embedded in the object, only the object may be registered on the mute list, and the region setting object may not be registered on the mute list. In that case, control may be performed to forbid the UGC embedded in the reported object to be displayed/output, and the rendering process of hiding the inside of the first region R1 may not be executed. The control may be performed on only a game system 1 operated by a reporter, all game systems 1 of users that are playing a game using the same game space, or all the game systems 1, except for the game system 1 of the user (e.g., the first user) that has set the first region R1.

In another example, when the second user reports an object arranged in the first region R1 as a matter to be reported, and the UGC is embedded in the object, the region setting object A1 setting the first region 1 may be registered on the mute list. In that case, the UGC embedded in the reported object may be displayed with at least a portion thereof hidden, by the rendering process of hiding the inside of the first region R1.

In addition, in another example, when an object arranged in the first region R1 is reported as a matter to be reported by the second user, and the UGC is embedded in the object, both the object in which the UGC is embedded and the region setting object A1 setting the first region R1 may both be registered on the mute list. In that case, in addition to the rendering process of hiding the inside of the first region R1, the control to forbid the UGC embedded in the reported object to be displayed/output may be performed.

In addition, in the present example, for example, when a user region (e.g., the first region R1) reported by a reporter further satisfies a predetermined condition, a state of the user region may be changed or the inside of the user region may be able to be edited.

Concerning determination of whether or not the predetermined condition is satisfied, the predetermined condition may be satisfied if the same region setting object has been reported a predetermined number of times (including only one time), for example. In that case, the predetermined condition may be satisfied if the same region setting object has been reported a predetermined total of times from different reporters.

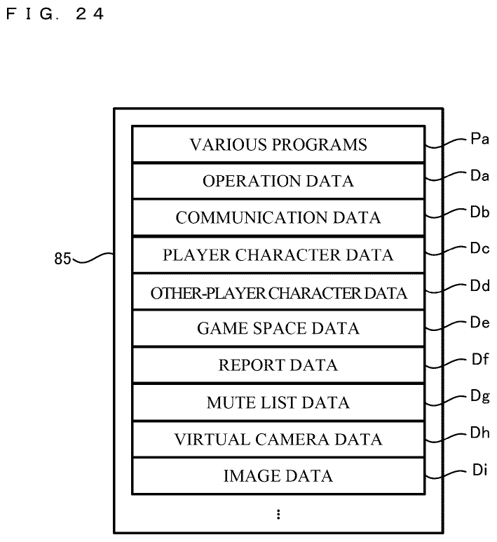

Next, an example a specific process executed by the game system 1 will be described with reference to FIG. 24. It should be noted that data used in other processes are stored in the DRAM 85 in addition to the data illustrated in FIG. 24, and will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, a communication program for communicating with other apparatuses (the server 102 and other game systems 1), and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, communication data Db, player character data Dc, other-player character data Dd, game space data De, report data Df, mute list data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The communication data Db includes transmission data to be transmitted to other apparatuses (the server 102 and other game systems 1) and reception data received from other apparatuses. For example, the transmission data includes information about the action, state, and the like of a player character PC operated by the user of the game system 1, information about a reported, information about a game space changed by the player character PC's action, and the like. In addition, the reception data includes information about the actions, states, and the like of other player characters PC operated by the users of other game systems 1, information about a game space changed by the other player characters PC, and the like.

The player character data Dc indicates parameters such as the position, direction, pose, action, state, ability, remaining energy, and the like in a game space of a player character operated by the user of the game system 1 (hereinafter referred to as a first player character PC1), and the like. The other-player character data Dd indicates parameters such as the positions, directions, poses, actions, states, abilities, remaining energies, and the like in a game space of other player characters operated by the users of other game systems 1 (hereinafter referred to as a the second player character PC2), and the like.

The game space data De indicates a state of a game space. For example, the game space data De indicates a parameter related to a state of a terrain object L and a parameter related to a state of a decorative object for each coordinate point set in a game space, e.g., a parameter indicating whether or not an object L (a terrain object, a decorative object, a particular object, etc.) exists at each of a plurality of coordinate points, and parameters indicating the type, state, and the like (including an editor, embedded information, and texture) of an existing object.

The report data Df is related to data indicating a matter to be reported by the user of the game system 1.

The mute list data Dg indicates a matter to be rendered to be hidden in response to a report, and indicates a list on which the ID of a region setting object set as a matter to be reported and the ID of an object set as a matter to be reported.

The virtual camera data Dh indicates the position, orientation, angle of view, and the like of a virtual camera arranged in the game space.

The image data Di is for displaying images (e.g., an image of each player character PC, an image of each object, a map image, and a background image) on a display screen (e.g., the display 12 of the main body apparatus 2).

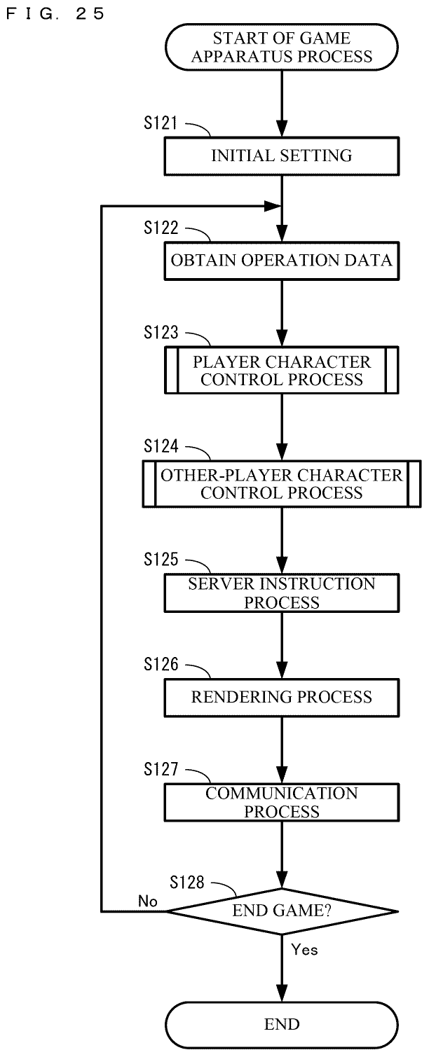

Next, a detailed example of a game process that is an example of an information process in the present example will be described with reference to FIGS. 25 to 28. In the present example, a series of steps illustrated in FIGS. 25 to 28 is executed by the processor 81 executing a predetermined application program (game program), a communication program, and the like included the programs Pa. The game process of FIGS. 25 to 28 is started with any appropriate timing.

It should be noted that the steps in the flowcharts of FIGS. 25 to 28, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., the server 102 and other game systems 1 that can communicate with the main body apparatus 2 via a network). Specifically, the steps of FIGS. 25 to 28 may be executed by a plurality of information processing apparatuses including the main body apparatus 2 cooperating with each other.

In FIG. 25, the processor 81 executes initial setting for the game process (step S121), and proceeds to the next step. For example, in the initial setting, the processor 81 initializes parameters for executing processes described below, and updates each data. As an example, in the case in which it is necessary to log in on the server 102 in order to start a game in which a plurality of users participate, the processor 81 performs a log-in process on the server 102 according to a log-in operation indicated by the operation data Da. The processor 81 obtains data related to a game space that has been allocated to the user by the log-in process, and produces a game space based on the data. Thereafter, the processor 81 arranges a first player character PC1, a virtual camera, and the like in a predetermined pose or orientation at a default position in the game space, and updates the player character data Dc, the game space data De, and the virtual camera data Dh. In addition, the processor 81 sets a user region based on the position of a particular object associated with the first player character PC1 in the game space according to a situation of the particular object (e.g., when a game is started from the beginning, the particular object is arranged at a default position, and when a game is resumed from the middle, or a situation before a pause in a game is set based on data obtained in the log-in process and the like), and sets the game space data De.

Next, the processor 81 obtains operation data from the left controller 3, the right controller 4, and/or the main body apparatus 2, and updates the operation data Da (step S122), and proceeds to the next step.

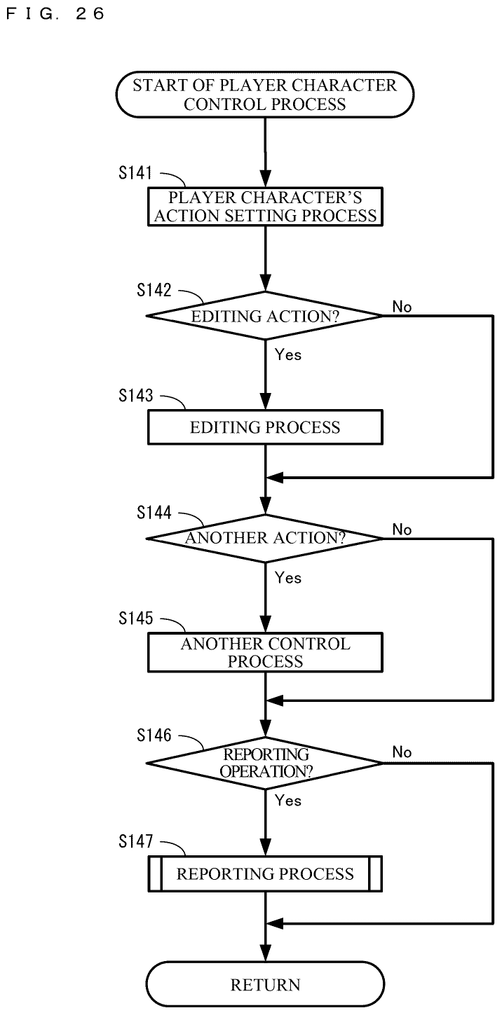

Next, the processor 81 executes a player character control process (step S123), and proceeds to the next step. The player character control process in step S123 will be described below with reference to FIG. 26.

In FIG. 26, the processor 81 executes a process of setting an action of a first player character PC1 (step S141), and proceeds to the next step. For example, the processor 81 sets the position, direction, pose, action, state, and the like of the first player character PC1 based on an operation input indicated by the operation data Da, virtual physical calculation in the game space (e.g., virtual inertia and gravity), and the like, and updates the player character data Dc.

Next, the processor 81 determines whether or not the first player character PC1's action of editing an object (a terrain object, decorative object, particular object, or the like) has been set (step S142). If the action of editing an object has been set, the processor 81 proceeds to step S143. Otherwise, i.e., if the action of editing an object has not been set, the processor 81 proceeds to step S144.

In step S143, the processor 81 executes a process of editing an object in the game space, and proceeds to step S144. For example, the processor 81 edits an object to be edited in the game space (a terrain object, decorative object, particular object, or the like) based on the first player character PC1's set action, and updates the parameters of the object based on the editing to update the game space data De. In addition, the processor 81 sets the editor of the edited object to the first player character PC1, and updates the game space data De. As an example, if in step S143, a region setting object in the game space has been edited, the processor 81 updates the parameters of the region setting object based on the editing, and sets a user region (e.g., first region R1) of the user operating the first player character PC1, depending on the position of the region setting object, to update the game space data De. It should be noted that as described above, the editing of an object includes updating of various states of an object such as creation, movement, deletion, duplication, joining, changing of appearance, and embedding of information, which will not be herein described.

In step S144, the processor 81 determines whether or not the first player character PC1's set action is any other action. If the first player character PC1's set action is any other action, the processor 81 proceeds to step S145. Otherwise, i.e., if the first player character PC1's set action is not any other action, the processor 81 proceeds to step S146.

In step S145, the processor 81 executes another control process, and proceeds to step S146. As an example, if the operation data Da indicates that an operation instruction to display and move the aiming point T has been issued, the processor 81 moves the position of the aiming point T according to the operation instruction, and provides a setting to display information I of an object overlaid by the aiming point T (see FIGS. 12 and 19).

In step S146, the processor 81 determines whether or not the user has performed an operation of reporting. For example, if the operation data Da indicates an operation input that is an operation of reporting, the result of the determination by the processor 81 in step S146 is positive. If an operation of reporting has been performed, the processor 81 proceeds to step S147. Otherwise, i.e., if an operation of reporting has not been performed, the processor 81 ends the subroutine.

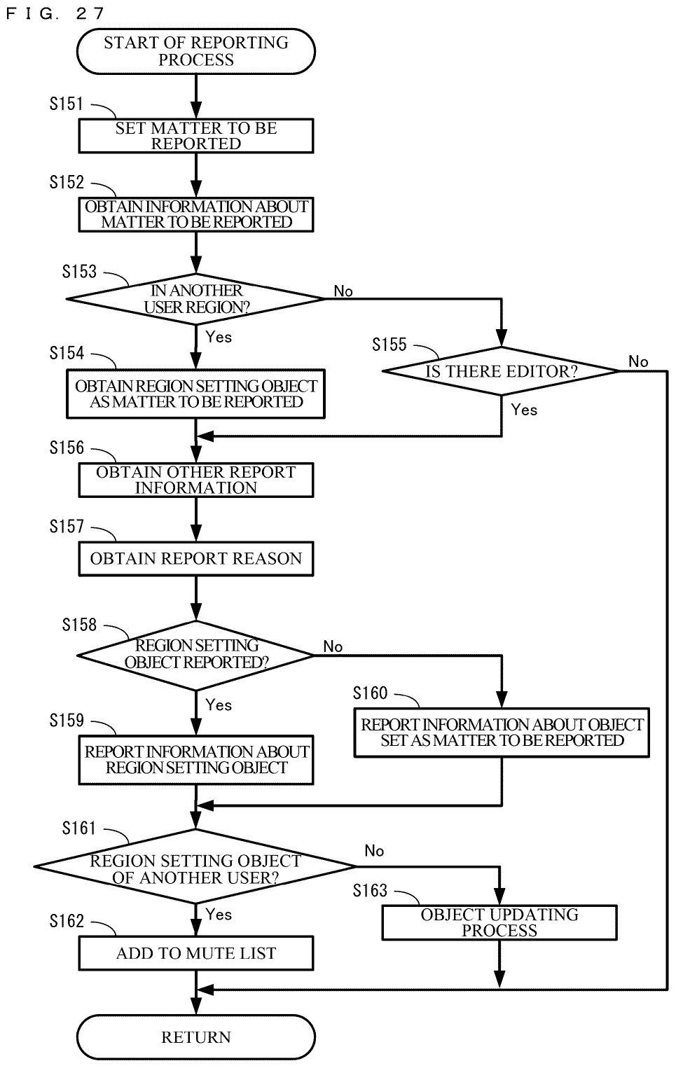

In step S147, the processor 81 executes a reporting process, and ends the subroutine. The reporting process in step S147 will be described below with reference to FIG. 27.

In FIG. 27, the processor 81 sets a matter to be reported (step S151), and proceeds to the next step. For example, the processor 81 sets, as a matter to be reported, an object based on the position of the first player character PC1 (e.g., an object arranged at the foot or immediately in front of the first player character PC1) or an object overlaid by the aiming point T.

Next, the processor 81 obtains information about the matter to be reported (step S152), and proceeds to the next step. For example, the processor 81 looks up the game space data De to retrieve data related to the position in the game space of an object set as the matter to be reported, and a user region in which the object is arranged, the user ID of the editor of the object, and the like, as information about the matter to be reported.

Next, the processor 81 determines whether or not the matter to be reported is arranged in a user region (step S153). For example, if the matter to be reported is arranged in a user region, the processor 81 proceeds to step S154. Otherwise, i.e., if the matter to be reported is not arranged in a user region, the processor 81 proceeds to step S155.

In step S154, the processor 81 sets a region setting object as a matter to be reported, obtains information about the region setting object, and proceeds to step S156. For example, the processor 81 sets a region setting object setting a user region in which the object set as a matter to be reported in step S151, as a new matter to be reported, with reference to the game space data De. Thereafter, the processor 81 looks up the game space data De to retrieve information such as the ID of the region setting object set as the new matter to be reported and the use ID of the user (editor) that has set the region setting object.

Meanwhile, in step S155, the processor 81 determines whether or not an editor other than the user of the apparatus including the processor 81 is registered in the information about the matter to be reported obtained in step S152. If an editor other than the user of the apparatus including the processor 81 is registered, the processor 81 proceeds to step S156. Otherwise, i.e., if the user of the apparatus including the processor 81 is registered as an editor, or no editor is registered, the processor 81 ends the subroutine. In this case, the processor 81 may set an image indicating that reporting has failed, and perform control to display the image in step S126 described below, thereby notifying the user that reporting has failed.

In step S156, the processor 81 obtains other report information related to the object as a matter to be reported obtained in step S152, and proceeds to the next step.

Next, the processor 81 obtains a report reason of the user (step S157), and proceeds to the next step. For example, the processor 81 presents options for a report reason to the user to prompt the user to select one from the options, and obtains a report reason of the user based on the selected option. It should be noted that in the present example, there may be only one fixed report reason (e.g., a report reason for determining that an object is inappropriate). In that case, step S157 may be removed.

Next, the processor 81 determines whether or not the region setting object has been set as a matter to be reported (step S158). If the region setting object has been set as a matter to be reported, the processor 81 proceeds to step S159. Otherwise, i.e., if the region setting object has not been set as a matter to be reported, the processor 81 proceeds to step S160.

In step S159, the processor 81 reports information about the region setting object set as a matter to be reported to the server 102, and proceeds to step S161. For example, the processor 81 sets information such as the ID of the region setting object set as a matter to be reported into the report data Df with reference to the game space data De. Thereafter, the processor 81 transmits and reports the report data Df thus set, as transmission data, to the server 102 in a communication process in step S127 described below.

Meanwhile, in step S160, the processor 81 reports information about the object set as a matter to be reported to the server 102, and proceeds to step S161. For example, the processor 81 sets information related to coordinates of the object in the game space into the report data Df with reference to the game space data De. Thereafter, the processor 81 transmits and reports the report data Df thus set, as transmission data, to the server 102 in a communication process in step S127 described below.

In step S161, the processor 81 determines whether or not a region setting object set by another user has been set as a matter to be reported. If a region setting object set by another user has been set as a matter to be reported, the processor 81 proceeds to step S162. Otherwise, i.e., if an object other than region setting objects or a region setting object of the user of the apparatus including the processor 81 has been set as a matter to be reported, the processor 81 proceeds to step S163.

In step S162, the processor 81 registers the region setting object set as a matter to be reported on the mute list, and ends the subroutine. For example, the processor 81 registers the ID of the region setting object set as a matter to be reported on the mute list, and updates the mute list data Dg.

Meanwhile, in step S163, the processor 81 executes a process of updating a state of the object as a matter to be reported, and ends the subroutine. For example, the processor 81 changes a state (appearance) of the object itself set as a matter to be reported in step S151, and updates the game space data De. As a first example, the processor 81 deletes UGC (text information, image information, audio information, etc.) embedded in the object as a matter to be reported, or forbids the UGC to be displayed/output, and updates the game space data De of the object. As a second example, the display form of the object as a matter to be reported is changed so as to indicate that the object is a matter to be reported (e.g., the appearance is changed to one indicating the material “soil”), and the game space data De of the object is updated. As a third example, in the case in which the object as a matter to be reported is obtained by joining a plurality of objects together, a portion of the plurality of objects for which an editor has been set are forbidden to be displayed, and the game space data De of the object is updated.

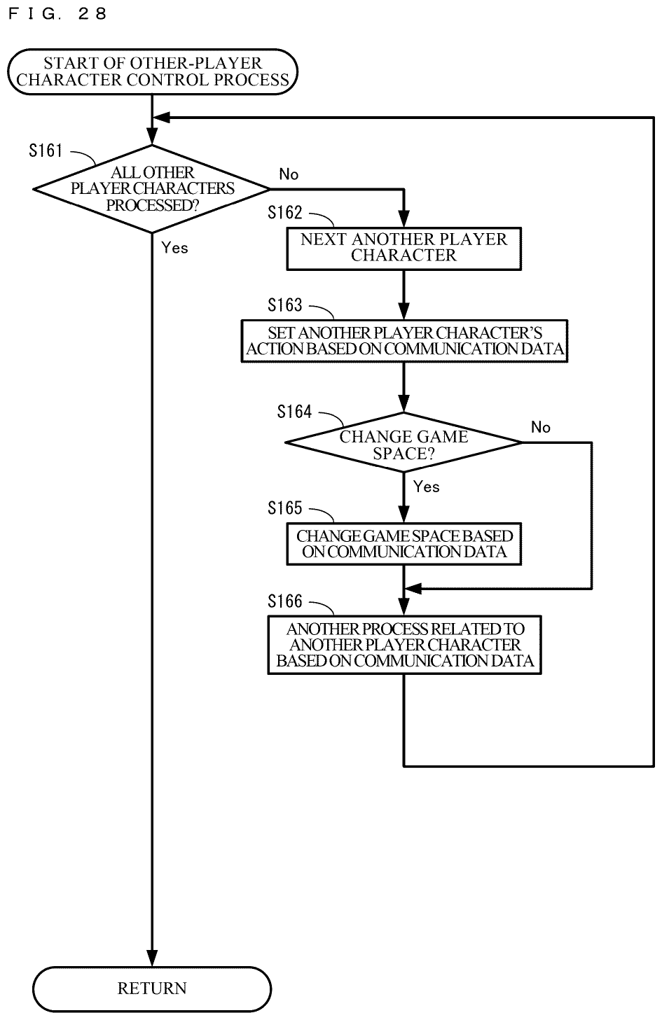

Referring back to FIG. 25, after the player character control process in step S123, the processor 81 performs an other-player character control process (step S124), and proceeds to step S125. The other-player character control process in step S124 will be described below with reference to FIG. 28.

In FIG. 28, the processor 81 determines whether or not all of steps S162 to S166 have been completed for all other player characters PC arranged in the game space (step S161). If steps S162 to S166 have not been completed for all other player characters PC, the processor 81 proceeds to step S162. Otherwise, i.e., if steps S162 to S166 have been completed for all other player characters PC, the processor 81 ends the subroutine.

In step S162, the processor 81 chooses a player character PC for which steps S162 to S166 have not been completed, of all other player characters PC arranged in the game space, and proceeds to the next step.

Next, the processor 81 sets an action of another player character PC that is to be processed, based on the communication data Db (step S163), and proceeds to the next step. For example, the processor 81 retrieves, from the communication data Db, information about another player character PC to be processed that is received from the game system 1 of another user that is operating the another player character PC through the server 102, sets the another player character PC's action based on said information, and updates the other-player character data Dd. It should be noted that, in the game system 1 of the another user, processes including step S123 are performed on the player character PC operated by the another user, and said game system 1 transmits communication data generated according to the result of the processes through the server 102. Thereafter, in step S127 described below, data transmitted from the game system 1 of another user through the server 102 is received and stored into the communication data Db as appropriate, and in step S163 or steps S164 to S166 described below, the data thus stored in the communication data Db is used.

Next, the processor 81 determines, based on the communication data Db, whether or not the game space has been changed by an action of another player character PC to be processed (step S164). For example, the processor 81 determines whether or not the game space has been changed by another player character PC to be processed, based on information about the game space received from the game system 1 of the another user operating the another player character PC through the server 102. If the game space has been changed by the another user operating the another player character PC to be processed, the processor 81 proceeds to step S165. Otherwise, i.e., if the game space has not been changed by the another user operating the another player character PC to be processed, the processor 81 proceeds to step S166.

In step S165, the processor 81 performs a process of changing the game space based on an action of the another player character PC to be processed, based on the communication data Db, and proceeds to step S166. For example, the processor 81 retrieves, from the communication data Db, information about the game space changed by the action of another player character PC to be processed that has been received from the game system 1 of another user operating the another player character PC through the server 102. Thereafter, based on the information, the processor 81 updates a parameter at a coordinate point in the game space related to an object edited by the action of the another player character PC to be processed, to update the game space data De. As an example, when a region setting object has been edited in the game space by an action of another player character PC to be processed, a user region is set based on the position of the region setting object, and the game space data De is updated.

In step S166, the processor 81 executes another process related to another player character PC to be processed, and returns to and repeats step S161.

Referring back to FIG. 25, after the other-player character control process in step S124, the processor 81 performs a server instruction process (step S125), and proceeds to the next step. For example, if the communication data Db indicates that instruction data has been received from the server 102, the processor 81 executes a process based on the instruction data. As an example, if violation handling instruction data has been received from the server 102, the processor 81 updates a state of the game space based on the violation handling instruction data, and updates the game space data De.

Next, the processor 81 executes a rendering process (step S126), and proceeds to the next step. In the present example, the processor 81 perform control to display, on the display 12, an image of the game based on the result of steps S122 to S125 or a reporting image. As an example, the processor 81 sets the game space including each object, a user region, an aiming point, letter information, image information, and the like based on the result of the above process and the game space data De. In addition, the processor 81 arranges and causes each player character PC to perform an action in the game space based on the player character data Dc and the other-player character data Dd. In addition, the processor 81 sets the position and/or orientation of a virtual camera for producing a display image based on the virtual camera data Dh to arrange the virtual camera in the game space. Thereafter, the processor 81 generates an image of the game space as viewed from the virtual camera thus set, and controls the display 12 so that the game space image is displayed on the display 12. It should be noted that the processor 81 may execute a process of controlling the movement of the virtual camera in the game space based on the position and pose of the first player character PC1, and update the virtual camera data Dh. It should be noted that the processor 81 may move the virtual camera based on the operation data Da, and updates the virtual camera data Dh.

In addition, in step S126, the processor 81 executes a rendering process based on the mute list. For example, for a user region set by a region setting object registered on the mute list indicated by the mute list data Dg, the processor 81 executes a rendering process including the effect of hiding the inside of the user region from the outside of the user region. As an example, if the position of the virtual camera indicated by the virtual camera data Dh is outside the user region, then when the processor 81 is instructed to generate an image of the game space including the user region as viewed from the virtual camera, the processor 81 performs control to display the image of the game space on the display 12 by executing a rendering process using the effect of hiding the inside of the user region to generate the image of the game space in which the inside of the user region is not seen (see FIG. 20). In addition, when the position of the virtual camera indicated by the virtual camera data Dh is inside the user region, the processor 81 performs control to display the image of the game space on the display 12 by generating the image of the game space in which both the inside and outside of the user region are seen, without executing a rendering process of the above effect (see FIG. 22). It should be note that when the first player character PC is arranged at a position where at least a portion of the first player character PC is hidden by the above effect, the processor 81 executes a rendering process of displaying the portion of the first player character PC hidden by the effect, in silhouette (see FIG. 21).

Next, the processor 81 performs a communication process (step S127), and proceeds to the next step. For example, the processor 81 prepares transmission data to be transmitted to the server 102, stores the transmission data into the communication data Db, and transmits the transmission data to the server 102. In addition, the processor 81 stores data received from the server 102 into the communication data Db. As an example, the processor 81 prepares information related to the action, state, and the like of a player character PC operated by the user (the first player character PC1) based on the player character data Dc, and stores the information as a portion of the transmission data into the communication data Db. In addition, the processor 81 prepares, based on the game space data De, information related to an object edited by the player character PC operated by the user, information related to the user region associated with the player character PC operated by the user, and the like, as information related to the game space changed by an action of the player character PC, and stores the prepared information as a portion of the transmission data into the communication data Db. In addition, the processor 81 stores data related to a matter to be reported that is stored in the report data Df, as a portion of the transmission data, into the communication data Db.

Next, the processor 81 determines whether or not to end the game process (step S128). In step S128, the game process is ended, for example, if a condition for ending the game process is satisfied, the user has performed an operation of ending the game process, the user has performed an operation of logging off, or the like. If the processor 81 determines not to end the game process, the processor 81 returns to and repeats step S122. Otherwise, i.e., if the processor 81 determines to end the game process, the processor 81 transmits data indicating ending of the game (logging off) to the server 102, and ends the flowchart. Following this, steps S122 to S128 are repeatedly executed until the processor 81 determines to end the game process in step S128.

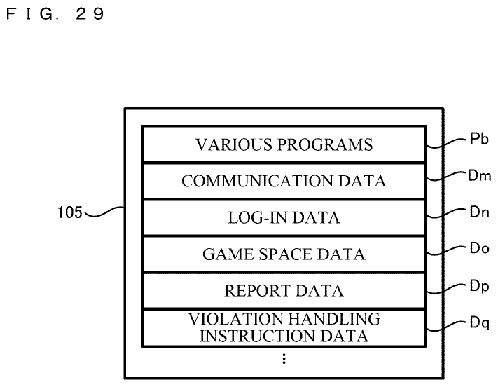

Next, data and programs stored in the storage section 105 of the server 102 will be described with reference to FIG. 29. Although the server 102 also stores data used in other processes in addition to the data of FIG. 29, such additional data will not be described in detail.

As illustrated in FIG. 29, the data storage area of the storage section 105 stores communication data Dm, log-in data Dn, game space data Do, report data Dp, violation handling instruction data Dq, and the like. In addition, the program storage area of the storage section 105 stores various programs Pb for carrying out the above processes.

The communication data Dm stores reception data that has been received from each game system 1, and transmission data that is to be transmitted to each game system 1.

The log-in data Dn is used in a log-in process for each of the users of game systems 1. The log-in data Dn includes the ID, password, log-in/log-off state, log-in history, a game space in which a logged-in user is permitted to participate, and the like of each user, which are checked in the log-in process.

The game space data Do indicates a state of each game space and a state of a player character PC based on data related to a player character PC received from each game system 1, data related to an object and a user region in the game space of each game system 1, and the like.

The report data Dp is for managing a matter to be reported that has been reported by a user.

The violation handling instruction data Dq indicates how a matter to be reported that has been reported should be handled when the matter violates a predetermined rule.

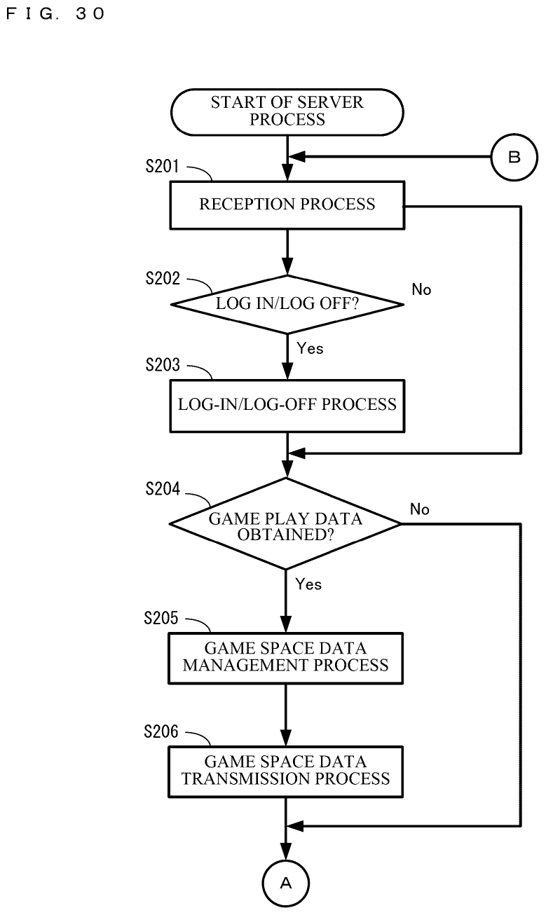

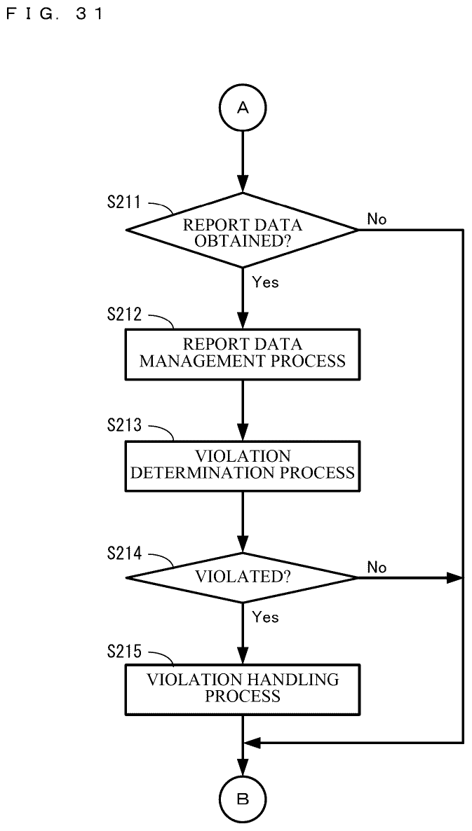

Next, processes that are executed in the server 102 will be described in detail below with reference to FIGS. 30 and 31. Here, in the flowcharts of FIGS. 30 and 31, of the processes of the information processing system 100, the above game process in which a game space is shared by player characters PC operated by a plurality of users that play a game will be mainly described, and other processes that are not directly involved with those processes will not be described in detail. In FIGS. 30 and 31, each step that is executed by the control section 104 is abbreviated to ‘S’.

It should be noted that the steps in the flowcharts of FIGS. 30 and 31, which are merely illustrative, may be executed in a different order, or another step may be executed in addition to and/or instead of each step, as long as a similar effect is obtained. In the present example, it is assumed that the control section 104 (CPU) executes each step of the flowcharts. Alternatively, a portion of the steps of the flowcharts may be executed by the control section 104 (CPU), and the other portions may be executed by a processor or dedicated circuit other than the control section 104 (CPU). In addition, all the steps of the flowcharts may be executed by a processor or dedicated circuit other than the control section 104 (CPU).

In FIG. 30, the control section 104 of the server 102 executes a process of receiving transmission data transmitted from each game system 1, and storing the transmission data into the communication data Dm (step S201), and proceeds to the next step.

Next, the control section 104 determines whether or not the data received in step S201 indicates a log-in/log-off operation (step S202). If the data is log-in data or log-off data, the control section 104 proceeds to step S203. Otherwise, i.e., if the data is neither log-in data nor log-off data, the control section 104 proceeds to step S204.

In step S203, the control section 104 executes a log-in/log-off process, and proceeds to the next step. As an example, the control section 104 determines whether or not to permit a user of a game system 1 that has transmitted log-in data to log in. If the control section 104 determines to permit a user of a game system 1 that has transmitted log-in data to log in, the control section 104 sets the user into a logged-in state, and updates the log-in data Dn. Thereafter, the control section 104 looks up the log-in data Dn and the game space data Do, selects a game space in which the user who has transmitted the log-in data is to participate, sets transmission data that indicates, to the user, log-in permission, a game space in which the user is permitted to participate, and information about the game space, into the communication data Dm, and transmits log-in data to the game system 1 of the user. As another example, the processor sets a user of a game system 1 who has transmitted log-off data to a logged-off state, and updates the log-in data Dn. Thereafter, the control section 104 sets, into the communication data Dm, transmission data indicating that a player character PC operated by the logged-off user is to be caused to disappear from the game space, and transmits the communication data Dm to game systems 1 of users which are involved with the game space in which said user has participated.

In step S204, the control section 104 determines whether or not the data received in step S201 is game play data. If the data received in step S201 is game play data, the control section 104 proceeds to step S205. Otherwise, i.e., if the data received in step S201 is not game play data, the control section 104 proceeds to step S211 (see FIG. 31).

In step S205, the control section 104 executes a game space data management process, and proceeds to the next step. For example, the control section 104 updates a state in each game space or a state of a player character PC based on data related to a player character PC or data related to an object or user region in a game space, which are indicated by the received game play data, and updates the game space data Do.

Next, the control section 104 executes a process of transmitting the game space data (step S206), and proceeds to step S211 (see FIG. 31). For example, the control section 104 sets, into the communication data Dm, data related to states of a game space and a player character PC updated based on the game play data of each user received in step S201, as transmission data that is to be transmitted to the game system 1 of each user that is participating in game play using the game space, and transmits the communication data Dm to the game systems 1 of the users.

Referring to FIG. 31, in step S211, the control section 104 determines, with reference to the communication data Dm, whether or not report data has been received from the game system 1. If report data has been received, the control section 104 proceeds to step S212. Otherwise, i.e., if report data has not been received, the control section 104 returns to and repeats step S201.

In step S212, the control section 104 executes a report data management process, and proceeds to the next step. For example, the control section 104 stores, into the report data Dp, report data required for a violation determination process such as the position, ID, and the like of a matter to be reported, based on the received report data.

Next, the control section 104 executes a violation determination process (step S213), and proceeds to the next step. For example, the control section 104 determines whether or not a matter to be reported that has been reported by a reporter satisfies a predetermined condition, thereby extracting a matter to be reported that violates a predetermined rule. In the violation determination process, the determination may be automatically performed based on a predetermined condition or may be performed by the manager of the server 102.

Next, the control section 104 determines whether or not the matter to be reported violates a predetermined rule, based on the result of the violation determination process of step S213 (step S214). If the matter to be reported violates a predetermined rule, the control section 104 proceeds to step S215. Otherwise, i.e., if the matter to be reported does not violate a predetermined rule, the control section 104 returns to and repeats step S201.

In step S215, the control section 104 executes a violation handling process, and returns to and repeats step S201. As an example, the control section 104 removes the setting of a user region that has been set as a matter to be reported, e.g., deletes the user region, and updates the game space data Do, and sets violation handling instruction data including an instruction to each game system 1 to perform the updating, into the communication data Dm, and transmits the communication data Dm. In addition, of objects whose editor is the user that has set a user region as a matter to be reported, the control section 104 may delete all objects arranged in the user region, and return the arrangement state of objects arranged in the user region to the initial state or a state before the user region has been set, and update the game space data Do, and may transmits the violation handling instruction data for instructing each game system 1 to perform the updating into the communication data Dm, and transmit the communication data Dm.

It should be noted that at least a portion of the above processes executed in the game system 1 may be executed by the server 102 or other apparatuses. In addition, at least a portion of the above processes executed by the server 102 may be executed by the game system 1 or other apparatuses. As an example, at least a portion of the reporting process in step S147 may be executed in the server 102, and a portion of the processes related to report data in steps S211 to S215 may be executed in the game system 1. As another example, the process of storing and managing the editor of an edited object (terrain object, decorative object) may be managed in the game system 1 by associating the object with the editor in the game system 1 each time the editing is performed, or data indicating that the editing has been performed may be managed in the server 102 by associating the object with the editor each time data indicating that the editing has been performed is received by the server 102.

Thus, in the present example, based on the user's reporting, at least a portion of a reported user region can be rendered and hidden from the user, and therefore, the user can continue to play a game without seeing a matter to be reported.

In addition, when a terrain object L is formed by digging the ground and therefore is determined to have an inappropriate shape, no terrain object L that has been edited by an editor does not exist, and therefore, there may be difficulty in determining a matter to be reported. In addition, when a portion of a content constituted by a plurality of terrain objects L or the like is set as a matter to be reported, then even if the portion is amended, the state that the content is determined to be inappropriate may remain. Furthermore, even when a reporter feels that a content is inappropriate, other users may not have a problem, or a false report may be made. In such a case, when a matter to be reported is deleted or returned to a default matter to be reported, or a penalty is imposed on the editor of a matter to be reported, users other than the reporter may have a disadvantageous situation. In addition, when a content created by editing performed by a plurality of editors is set as a matter to be reported, then if a penalty is imposed for a user that does not intentionally make an inappropriate content, the user has a disadvantageous situation.

Meanwhile, as described above, when a content that is determined to be inappropriate is arranged in a user region (e.g., the first region R1) set by a certain user (e.g., the first user), then if the user is trying to destroy the content, there is no editing right in the user region, and therefore, the inappropriate content continues to exit in the game space. The user is allowed to handle a content that it has been determined is inappropriate by themselves if the content is arranged outside the user region set by the another user. However, it may be necessary for the reporter to cause a content arranged in the user region set by the another user not to be seen. In the present example, at least a portion of the inside of a user region reported by the user can be rendered to be hidden from the user, based on the user's reporting. Therefore, even in the above cases, the user is allowed to continue to play a game without seeing a matter to be reported while preventing users other than the reporter from having a disadvantageous situation.

It should be noted that in the present example, data is managed for a player character PC, or a relevant process is executed for an action performed by a player character PC, for example. These examples are equivalent to the case in which these processes are executed for the user that operates the player character PC. As an example, although in the present example, a player character PC is registered as the editor of an object, the user that operates the player character PC (more specifically, the user ID that is an identifier assigned to the user) may be registered in association with the object. In that case, even when a user uses a plurality of player characters PC separately in the same game space, then if a report is made by each player character PC, only the user may receive the reports. For example, it can be said that an object that has been edited by a player character PC is associated with the user that operates the player character PC.

In addition, in the present example, an object (terrain object, decorative object) is edited by a player character PC's action, for example. Alternatively, an object may be edited according to a user's operation without through a player character PC. For example, by a user issuing a user specifying operation of directly specifying a position (coordinates) in the game space, an object associated with the user may be edited at the specified position. In that case, a player character operated by the user may not appear in the game space, the editor of the object directly specified by the user may be registered in response to an operation instruction to perform a predetermined action on the object.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example. In addition, the example operation button used in the above operation is merely illustrative, and the above examples may be implemented using other operation buttons. In addition, there may be a plurality of operation buttons having a similar function (e.g., an operation of giving a high rating (“like”) may be implemented even by pressing down any of the operation buttons 33 to 36 (cross button) or pressing down the operation button 53 (A-button) ).

The above programs may be supplied to the game system 1 or the server 102 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is useful as an information processing system, information processing program, information processing apparatus, information processing method, and the like that are capable of forbidding contents or the like to be seen from the user.

What is claimed is:

1. An information processing system comprising:
a server; and
a plurality of information processing terminals configured to connect to the server, wherein
the server is configured to
store a state in a first virtual space in which a plurality of objects are arranged,
update the stored state in the first virtual space based on a state of the objects updated based on operation inputs performed by users on the plurality of information processing terminals, and
store region information indicating at least one first user region and first user information indicating a first user in association with each other, wherein the at least one first user region is a first range in the first virtual space set based on an operation input performed by the first user on a first one of the plurality of information processing terminals, and
a second one of the plurality of information processing terminals is configured to
generate a second virtual space in which the objects are arranged, based on the state in the first virtual space stored in the server,
update a position of at least a virtual camera in the second virtual space based on an operation input performed by a second user on the second information processing terminal,
set a second range in the second virtual space related to the region information stored in the server, as at least one second user region,
designate one of the second user regions as a designated user region based on an operation input performed by the second user, and
when at least the virtual camera is located outside the designated user region, render an image of the second virtual space based on the virtual camera by a rendering process including a first effect of hiding at least a portion of the objects arranged in the designated user region.

2. The information processing system according to claim 1, wherein
the second information processing terminal is configured to move a player character from the outside of the designated user region to the inside of the designated user region in the second virtual space based on an operation input performed by the second user.

3. The information processing system according to claim 1, wherein
the rendering process includes, when the virtual camera is located inside the designated user region, rendering the image of the second virtual space in a state in which at least the objects that have been hidden by the first effect are not hidden by the first effect.

4. The information processing system according to claim 3, wherein
the rendering process includes
when the virtual camera is located outside the designated user region, rendering the image of the second virtual space in a state in which the entire designated user region is hidden by the first effect, and
when the virtual camera is located inside the designated user region, rendering the image of the second virtual space in a state in which the inside of the designated user region is not hidden by the first effect.

5. The information processing system according to claim 1, wherein
the rendering process includes, when the virtual camera is located inside the designated user region, rendering the image of the second virtual space in a state in which the outside of the designated user region is not hidden by the first effect.

6. The information processing system according to claim 1, wherein
the rendering process includes, when at least the virtual camera is located outside one of the second user regions that is not designated as the designated user region, rendering the image of the second virtual space in a state in which the inside of the one of the second user regions is not hidden by the first effect.

7. The information processing system according to claim 1, wherein
the rendering process includes rendering the image of the second virtual space with a first transparency lower than a second transparency by the first effect.

8. The information processing system according to claim 7, wherein
the rendering process includes, when at least the virtual camera is located outside one of the second user regions that is not designated as the designated user region, rendering the image of the second virtual space in a state in which the inside of the one of the second user regions has a transparency higher than the first transparency.

9. The information processing system according to claim 1, wherein
the second information processing terminal is configured to limit updating of a state of the objects arranged in the second user region based on an operation input performed by the second user.

10. The information processing system according to claim 9, wherein
the second information processing terminal is configured to set the second user region as the designated user region based on an operation input performed by the second user on the objects arranged in a range of the second user region.

11. The information processing system according to claim 10, wherein
the server is configured to
update the state in the first virtual space based on a designated object arranged based on an operation input performed by the first user, and
store the designated object, the region information indicating the first user region, and the first user information in association with each other, wherein a range in the first virtual space set based on the arranged designated object is the first user region, and
the second information processing terminal is configured to
set the designated user region by setting a range provided by the designated object related to the second user region as a range to be subjected to the rendering process, based on an operation input performed by the second user on an object arranged in a range of the second user region.

12. The information processing system according to claim 1, wherein
updating of the state of the objects based on which the state in the first virtual space is updated includes at least one of arranging the objects based on the user's operation input, removing the objects based on the user's operation input, changing texture of the objects based on the user's operation input, and embedding information related to the objects based on the user's operation input.

13. The information processing system according to claim 1, wherein
a third one of the plurality of information processing terminals is configured to
generate a third virtual space in which the objects are arranged, based on the state in the first virtual space stored in the server,
set a range in the third virtual space related to the region information stored in the server as at least one third user region, and
even when the second information processing terminal designates the second user region corresponding to one of the third user regions as the designated user region, render an image of the third virtual space in a state in which the objects arranged inside the third user region corresponding to the designated user region are not hidden by the first effect.

14. The information processing system according to claim 1, wherein
a third one of the plurality of information processing terminals is configured to
generate a third virtual space in which the objects are arranged, based on the state in the first virtual space stored in the server,
update a position of at least a virtual camera in the third virtual space based on an operation input performed by a third user on the third information processing terminal,
set a range in the third virtual space related to the region information stored in the server as at least one third user region, and
when the second information processing terminal designates the second user region corresponding to one of the third user regions as the designated user region, and at least the virtual camera is located outside the third user region corresponding to the designated user region, render an image of the third virtual space based on the virtual camera, by a rendering process including the first effect of hiding at least a portion of the objects arranged inside the third user region.

15. The information processing system according to claim 1, wherein
the rendering process includes, when the virtual camera is located outside the designated user region and a player character is arranged inside the designated user region, and at least a portion of the player character is hidden by the first effect, rendering the image of the second virtual space based on the virtual camera by displaying the player character in a manner that allows at least a contour of the hidden portion of the player character to be recognized.

16. A non-transitory computer-readable storage medium having stored therein an information processing program that when executed, causes one or more processors of an information processing apparatus to execute operations comprising:
updating a position of at least a virtual camera in a virtual space based on an operation input performed by a user of the information processing apparatus;
designating one of other user regions set by users of other information processing apparatuses as a designated user region based on an operation input performed by the user of the information processing apparatus; and
when at least the virtual camera is located outside the designated user region, rendering an image of the virtual space based on the virtual camera by a rendering process including a first effect of hiding at least a portion of objects arranged inside the designated user region.

17. An information processing apparatus comprising one or more processing circuitry and one or more memories storing instructions that cause the one or more processing circuitry to perform operations comprising:
updating a position of at least a virtual camera in a virtual space based on an operation input performed by a user of the information processing apparatus;
designating one of other user regions set by users of other information processing apparatuses as a designated user region based on an operation input performed by the user of the information processing apparatus; and
when at least the virtual camera is located outside the designated user region, rendering an image of the virtual space based on the virtual camera by a rendering process including a first effect of hiding at least a portion of objects arranged inside the designated user region.

18. An information processing method performed on an information processing system including a plurality of information processing apparatuses, the information processing method comprising:
updating a position of at least a virtual camera in a virtual space based on an operation input performed by a user of the information processing apparatus;
designating one of other user regions set by users of other information processing apparatuses as a designated user region based on an operation input performed by the user of the information processing apparatus; and
when at least the virtual camera is located outside the designated user region, rendering an image of the virtual space based on the virtual camera by a rendering process including a first effect of hiding at least a portion of objects arranged inside the designated user region.
